(19) United States
(12) Patent Application Publication
(10) Pub. No.: US 2023/0333435 A1
(43) Pub. Date: Oct. 19, 2023

(54) HEXAGONAL PACKING OF MULTI-SEGMENT ELECTRO-OPTICAL DEVICES

(71) Applicant: GENTEX CORPORATION, Zeeland, MI (US)

(72) Inventors: Xiaoxu Niu, Grand Rapids, MI (US); Kurtis L. Geerlings, Zeeland, MI (US)

(73) Assignee: GENTEX CORPORATION, ZEELAND, MI (US)

(21) Appl. No.: 18/135,227

(22) Filed: Apr. 17, 2023

Related U.S. Application Data
(60) Provisional application No. 63/332,006, filed on Apr. 18, 2022.

(51) Int. Cl. G02F 1/163; G02F 1/155

(52) U.S. Cl. CPC G02F 1/163; G02F 1/155; G02F 2001/1635; B60R 1/06

(57) ABSTRACT

An electro-optic device includes a first substrate and a second substrate. A first electrode is coupled to the first substrate and a second electrode is coupled to the second substrate. An electro-optic medium is disposed between the first electrode and the second electrode and is configured to be electro-activated between states. A plurality of transistors are in electrical communication with the electro-optic medium to switch localized regions of the electro-optic medium between states.

### CROSS-REFERENCE TO RELATED APPLICATION

This application claims priority to and the benefit under 35 U.S.C. § 119(e) of U.S. Provisional Application No. 63/332,006, filed on Apr. 18, 2022, entitled “HEXAGONAL PACKING OF MULTI-SEGMENT ELECTRO-OPTICAL DEVICES,” the disclosure of which is hereby incorporated herein by reference in its entirety.

### TECHNOLOGICAL FIELD

The present disclosure relates generally to electro-optic devices and, more particularly, relates to an electro-optic device having individually-controlled electro-optic segments.

### SUMMARY OF THE INVENTION

According to one aspect of the disclosure, an electro-optic device includes a first substrate and a second substrate. A first electrode is coupled to the first substrate and a second electrode is coupled to the second substrate. An electro-optic medium is disposed between the first electrode and the second electrode and is configured to be electro-activated between states. A plurality of transistors are in electrical communication with the electro-optic medium to switch localized regions of the electro-optic medium between states.

According to another aspect of the disclosure, an electro-optic device includes a first substrate and a second substrate. A first electrode is coupled to the first substrate and a plurality of intermediate electrodes are coupled to the second substrate. An electro-optic medium is disposed between the first electrode and the plurality of intermediate electrodes and is configured to be electro-activated between states. A plurality of transistor arrays are in electrical communication with the electro-optic medium through the plurality of intermediate electrodes to switch localized regions of the electro-optic medium between states.

According to yet another aspect of the disclosure, an electro-optic device includes a first substrate and a second substrate. An electro-optic medium is disposed between the first substrate and the second substrate and is configured to be electro-activated between states. A plurality of transistors are in electrical communication with the electro-optic medium to switch localized regions of the electro-optic medium between states. The plurality of transistors are disposed in a hexagonal lattice.

These and other features, advantages, and objects of the present device will be further understood and appreciated by those skilled in the art upon studying the following specification, claims, and appended drawings.

### BRIEF DESCRIPTION OF THE DRAWINGS

The invention will now be described with reference to the following drawings, in which:

FIG. 1A is a perspective view of an automobile that incorporates an electro-optic device of the present disclosure;

FIG. 1B is a perspective view of an airplane that incorporates an electro-optic device of the present disclosure;

FIG. 1C is a perspective view of a building that incorporates an electro-optic device of the present disclosure;

FIG. 1D is a front view of a virtual or semi-virtual device that incorporates an electro-optic device of the present disclosure;

FIG. 2 is a disassembled view of an electro-optic device of a first construction according to an aspect of the present disclosure;

FIG. 3 is a cross-sectional view of the electro-optic device of FIG. 2;

FIG. 4 is a schematic view of the electro-optic device of FIG. 2 in electrical communication with control circuitry;

FIG. 5 is a partial perspective cross-sectional view of a switching layer of the electro-optic device of FIG. 2;

FIG. 6 is a cross-sectional view of the electro-optic device of a second construction incorporating two switching layers;

FIG. 7 is a schematic view of the electro-optic device of FIG. 6 in electrical communication with control circuitry;

FIG. 8A is a disassembled view of an electro-optic device illustrating a plurality of element electrodes according to one aspect of the present disclosure;

FIG. 8B is a top view of a plurality of electro-optic segments that receive power from the element electrodes;

FIG. 8C is a schematic view illustrating size and spatial relationships between the element electrodes and the electro-optic segments;

FIG. 8D is a top view of a transistor array according to one aspect of the present disclosure;

FIG. 8E is a top view of a transistor array according to another aspect of the present disclosure;

FIG. 8F is a top view of a transistor array according to yet another aspect of the present disclosure;

FIGS. 9A and 9B are top views of an electro-optic device incorporating an array of electro-optic segments;

FIGS. 9C and 9D are top views of an electro-optic device incorporating an array of electro-optic segments in accordance with another aspect of the present disclosure;

FIG. 10 is a partial cross-sectional view of the electro-optic device of FIG. 8;

FIG. 11 is a partial perspective cross-sectional view of a switching layer of an electro-optic device of FIGS. 8A through 8C;

FIG. 12 is a schematic view of an electro-optic device in electrical communication with control circuitry;

FIG. 13 is a schematic view of the electro-optic device of FIG. 10 in electrical communication with control circuitry;

FIG. 14 is a schematic view of the electro-optic device in electrical communication with analog components of control circuitry; and

FIG. 15 is a schematic view of power supply circuitry for an electro-optic device according to one aspect of the present disclosure.

### DETAILED DESCRIPTION OF EMBODIMENTS

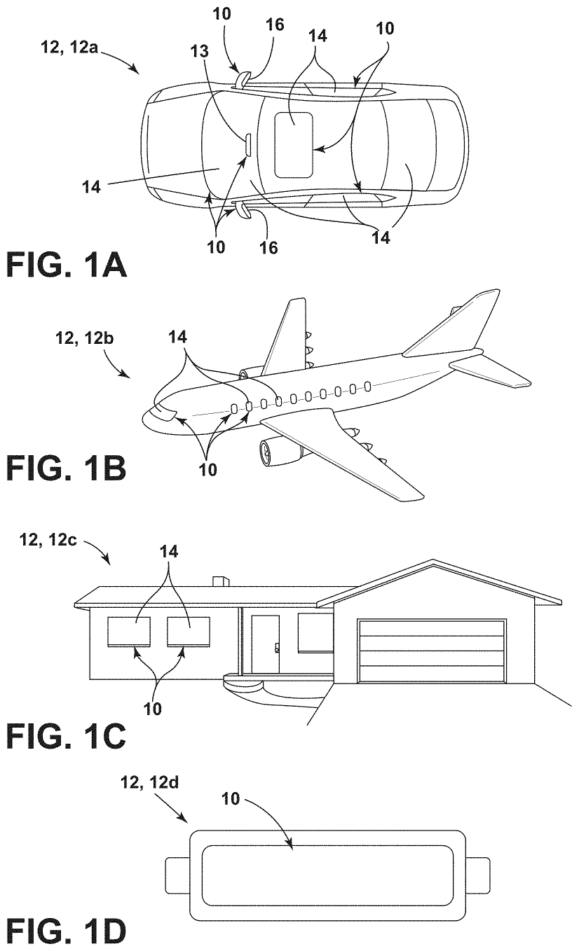

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

As defined herein, “substantially,” when used in reference to electrical properties, optical properties (such as light transmissivity), and the like, may, in some embodiments, mean within ten percent of a target state (e.g. 100%). In other embodiments, “substantially” may mean within five percent of the ideal state. In further embodiments, “substantially” may mean within three percent of the ideal state. In yet other embodiments, “substantially” may mean within one percent of the ideal state. By way of example, “opaque” have an ideal state of approximately 0% light transmissivity, while “transparent” may have an ideal state of approximately 100% light transmissivity.

The order in which the surfaces of sequentially positioned structural elements of the assembly (such as substrates made of glass or other translucent material) are viewed is the order in which these surfaces are referred to as the first surface, the second surface, the third surface, and other surfaces if present referred to in ascending order. Generally, therefore, surfaces of the structural elements (such as substrates) of an embodiment of the invention are numerically labeled starting with a surface that corresponds to the top, or front, portion of a window assembly and that is proximal to the observer or user of the assembly and ending with a surface that corresponds to the bottom, or back, portion of an assembly and that is distal to the user. Accordingly, the term “behind” refers to a position, in space, following something else and suggests that one element or thing is at the back of another as viewed from the front of the window assembly. Similarly, the term “in front of” refers to a forward place or position, with respect to a particular element as viewed from the front of the assembly.

According to some aspects of the present disclosure, an electro-optic device having improved responsiveness is disclosed. For example, the electro-optic device may include an electro-optic element with a plurality of transistors that may be controlled individually. The individualized control may prevent and/or limit the electro-optic device from producing a rising effect (i.e., darkening of a perimeter of the electro-optic device before darkening of a center of the electro-optic device). Moreover, each transistor may be arranged in a pattern that provides an improved packaging to increase responsiveness. Further, each transistor may darken electro-optic material in a radially symmetric (e.g., circular) localized region. The electro-optic device of the present disclosure provides a cost-effective construction by reducing the depth of the conductive material applied to the substrates of the electro-optic element. In addition, the electro-optic device may provide for a reduced bulbar footprint on the electrodes of the electro-optic element. These reductions may, in general, be due to fine control over electrical qualities (e.g., voltage, current) applied to the electro-optic device and, more particularly, to an electro-optic segment within the electro-optic device.

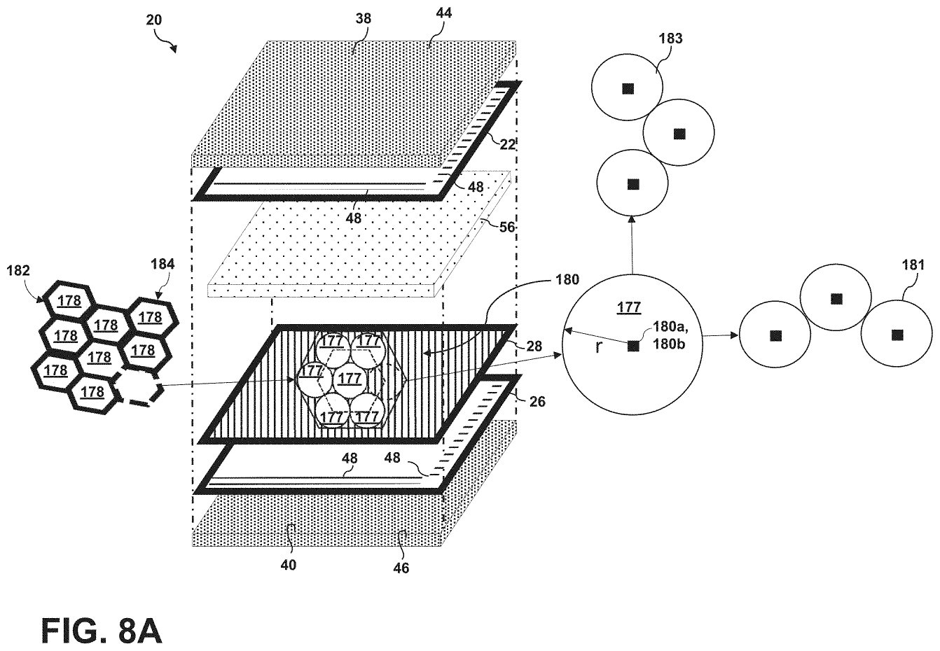

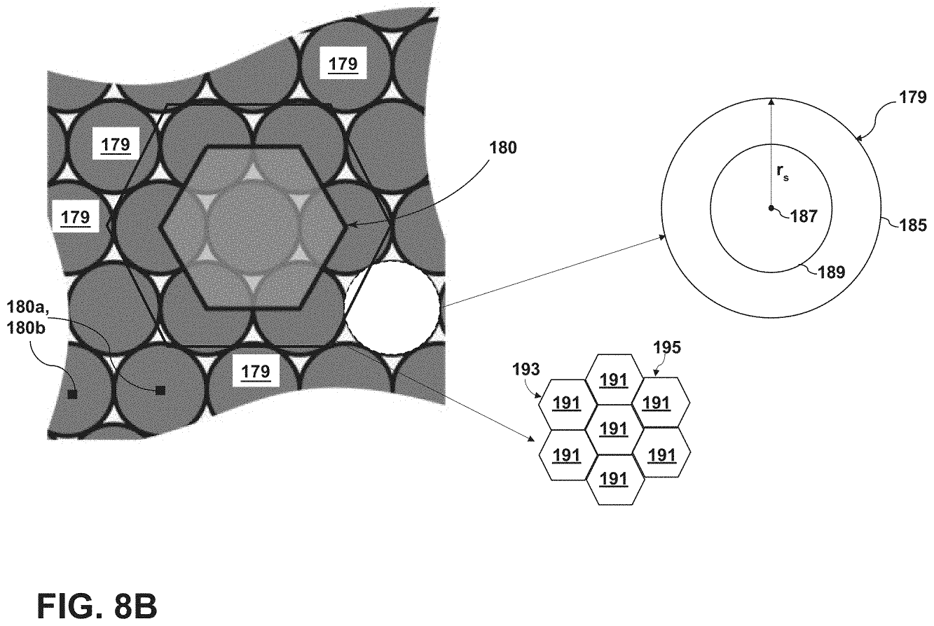

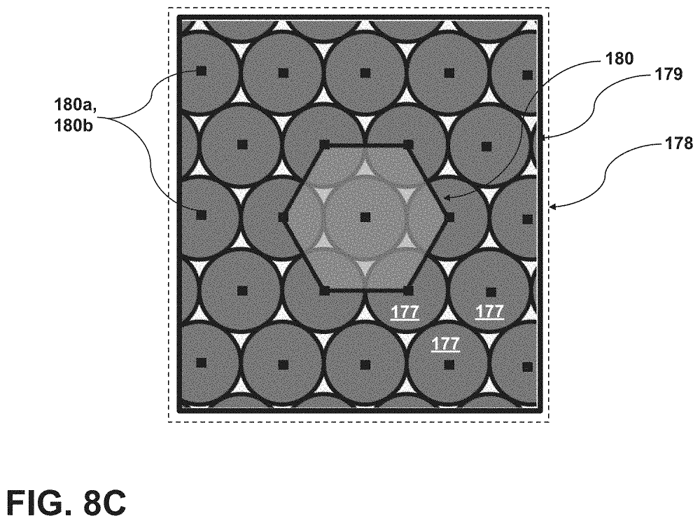

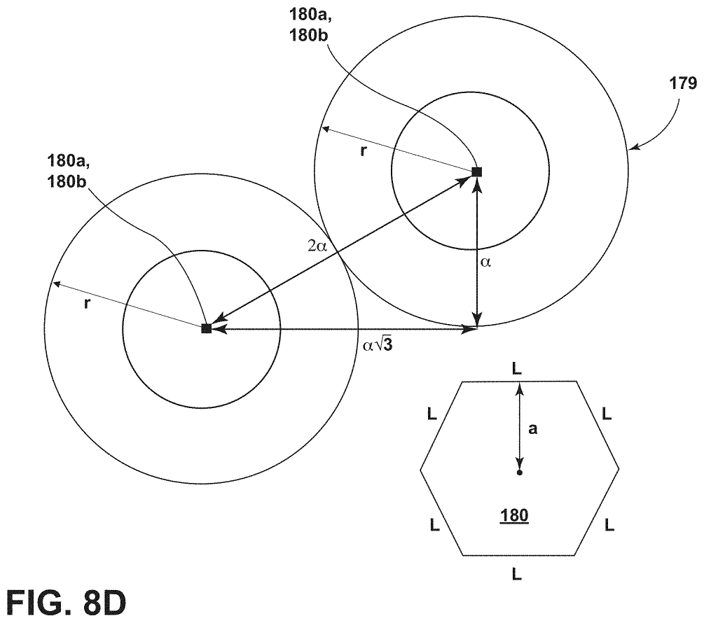

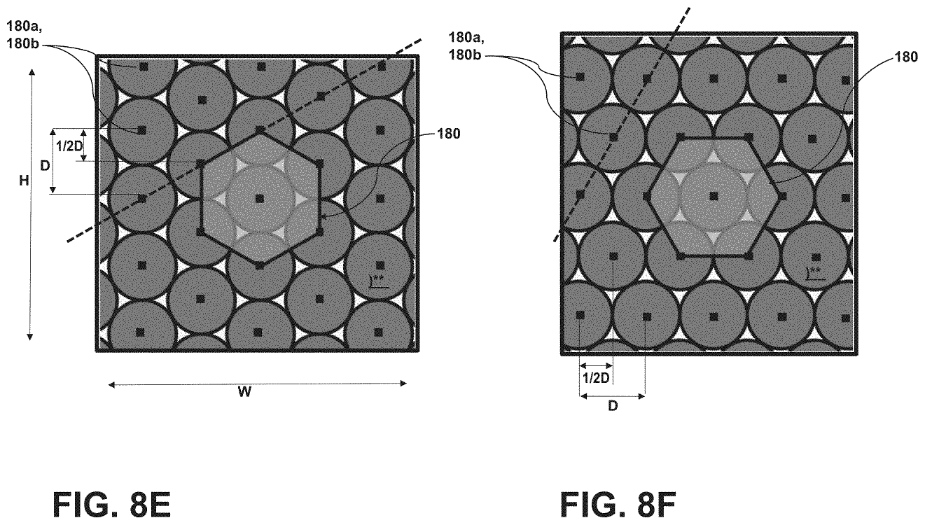

The electro-optic device may also provide for a single-sided power connection to the electro-optic element due to the individualized control. More specifically, because power may be provided to individual electro-optic segments (FIGS. 8A-11) of the electro-optic device, a high voltage (e.g., 6-10 V) may be provided to the electro-optic device without damaging components of the electro-optic device. The high voltage may be any voltage operable to power one segment of the electro-optic device (e.g., 0.7V to 1.2V) and/or may be any voltage operable to power a plurality of electro-optic segments (e.g., greater than approximately 1V). The high voltage may not be limited to a particular range of voltages. The voltage ranges described herein are intended to be exemplary and non-limiting. For example, the high voltage may be a minimum threshold voltage for powering the electro-optic segments to limit power consumption of the electro-optic device. In some arrangements, the supply voltage is dynamic and/or adjustable via manual or programmed control. Optionally, a ground or negative supply rail may be provided to improve clearing performance, or to allow the drive voltage be reduced for local areas. The high voltage may be stepped down for each electro-optic segment. The high voltage may also mitigate the issue of voltage drops that occur due to inherent resistance of the conductive material that may be employed in the electro-optic device. Further, the electro-optic device of the present disclosure may provide for faster and more uniform darkening and clearing of the electro-optic cell(s) by providing an array of the individually controlled transistors that are tightly packaged into arrays.

With reference to FIGS. 1A-1D, various embodiments of an electro-optic device 10 are incorporated with one or more structures 12. For example, FIG. 1A illustrates an automobile 12a employing one or more electro-optic devices 10 in the form of an interior rearview mirror 13, a window 14, and/or an exterior rearview mirror 16. FIG. 1B illustrates an airplane 12b employing one or more electro-optic devices 10 in the form of the window 14. FIG. 1C illustrates a building 12c employing one or more electro-optic devices 10 in the form of the window 14. The window 14 may be configured to provide a physical barrier between two areas and be operable to allow the variable transmission of light between the two areas. The window 14 may come in many configurations, such as a building window, a vehicle windshield, a side vehicle window, a rear vehicle window, a sunroof window, a heads-up display, or the like. The exterior rearview mirror 16 may be coupled to an automobile 12a exterior configured to provide a viewer with a field of view capturing a rear or side of the automobile 12a. The interior rearview mirror 13 may be a device in an automobile interior configured to provide a viewer with a field of view comprising a rearward exterior of automobile 12a. The interior and exterior rearview mirrors 13, 16 may be variably transmissive to minimize glare. FIG. 1D illustrates a virtual or semi virtual device 12d that may incorporate the electro-optic device 10. The virtual or semi virtual device 12d may be glasses, goggles, other display devices, and/or the like. The virtual or semi virtual device 12d may be configured as augmented reality (AR), extended reality (XR), Virtual Reality (VR), Mixed Reality (MR).

With continued reference to FIGS. 1A-1D, the electro-optic device 10 may provide segmented dimming to localized regions depending on the area that has active displayed content and provide max contrast ratio for the content. The transistor, electro-optic segment, and element electrode packaging as will be further described maximizes aperture ratio and therefore enables high transmission at a clear state. In this manner, segmented control can be utilized for preventing glare, displaying content, and/or the like. In other words, the electro-optic device 10 may be configured to switch between a partially transmissive state and a partially reflective state (e.g., a mirror) or between a partially reflective state and a partially opaque state (e.g., a window).

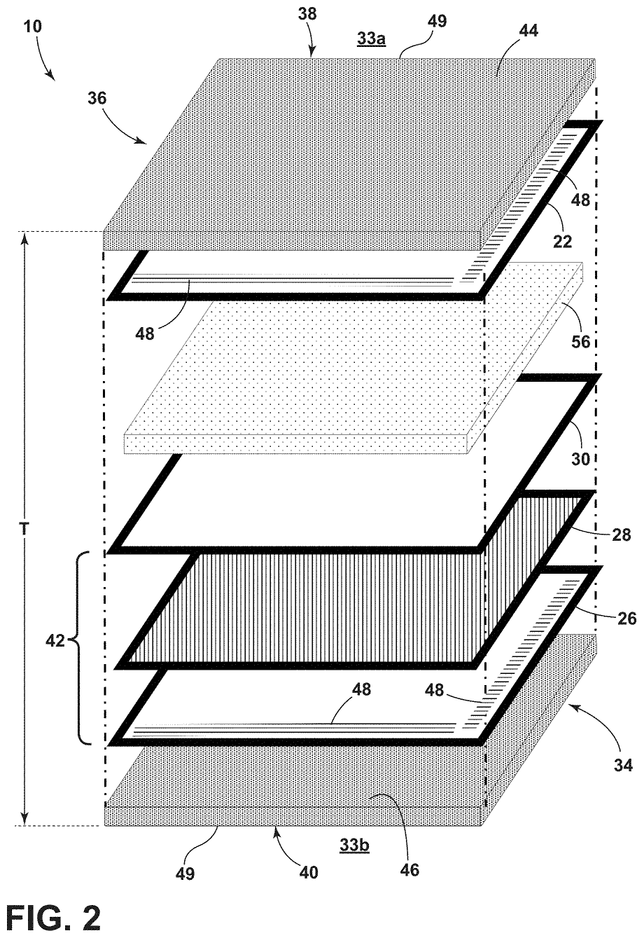

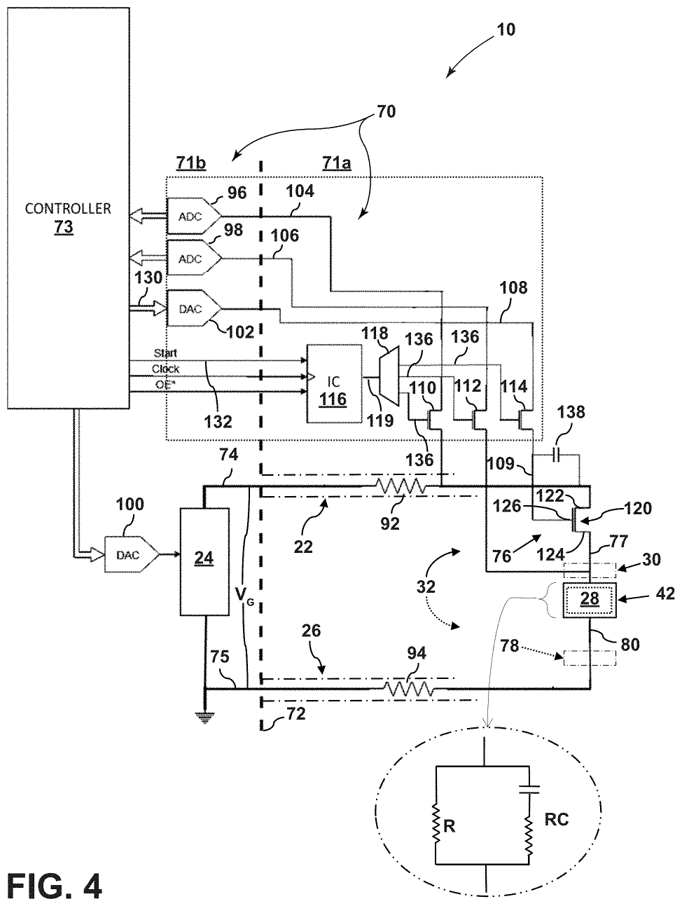

Referring to FIGS. 2-4, an electro-optic device 10 of a first construction that incorporates electrical switching and control components is provided. With respect to the physical construction of the electro-optic device 10, a first electrode 22 electrically connects with a power supply circuitry 24 (FIG. 4). A second electrode 26 may be spaced from the first electrode 22 and electrically connecting with the power supply circuitry 24. An electro-optic medium 28 may be disposed between the first electrode 22 and the second electrode 26. At least one third electrode 30 (e.g., an intermediate electrode 30) may be disposed between the first electrode 22 and the second electrode 26. As shown in FIG. 2, the intermediate electrode 30 may be electrically coupled with one of the first electrode 22 and/or the second electrode 26 via switching circuitry 32. The switching circuitry 32 may be operable to control an electrical current through the first electrode 22, the electro-optic medium 28, and the second electrode 26. The intermediate electrode 30 may be disposed toward a first portion 33a (e.g., a top portion) of the electro-optic device 10. The electro-optic device 10 may lack an intermediate electrode 30 disposed toward a second portion 33b (e.g., a bottom portion) of the electro-optic device 10. In such a configuration, the first portion 33a may be referred to as an “active plate” due to the individual control and/or monitoring of electrical parameters of the first portion 33a, and the second portion 33b may be referred to as a “passive plate” due to the lack of individual control and/or monitoring of the electrical parameters of the second portion 33b. However, it should be appreciated that, in some embodiments, the first portion 33a may be configured as a passage plate and the second portion 33b may be configured as an active plate.

The electro-optic device 10 may extend between a first end 34, along a length L of the electro-optic device 10, to a second end 36 opposite the first end 34. The electro-optic device 10 may also have a thickness T that extends between a first substrate 38 and a second substrate 40 of the electro-optic device 10. One or more electro-optic elements 42 may be disposed between the first substrate 38 and the second substrate 40 of the electro-optic device 10. The electro-optic element 42 may generally be formed from the second electrode 26, the electro-optic medium 28, and the intermediate electrode 30. The term “electro-optic element” may be used herein to primarily refer to an electrical characterization of the physical structures illustrated, and is not intended to be limited to any specific portion of the electrodes 22, 26, 30 or the electro-optic medium 28. It is further contemplated that one or more of the electro-optic elements 42 may include or otherwise be referred to as an electrochromic cell.

Each of the first substrate 38 and the second substrate 40 may extend between an outer surface 44 and an inner surface 46. The electro-optic element 42 may be sandwiched between the inner surfaces 46 of the first substrate 38 and the second substrate 40. An electrical connector 48 (e.g., busbar), may be provided at one or both ends 34, 36 of the electro-optic device 10 to provide a power connection to the electro-optic device 10. The electrical connector 48 may also, or alternatively, be positioned alongside edges 49 of the electro-optic device 10 on the first electrode 22 and the second electrode 26.

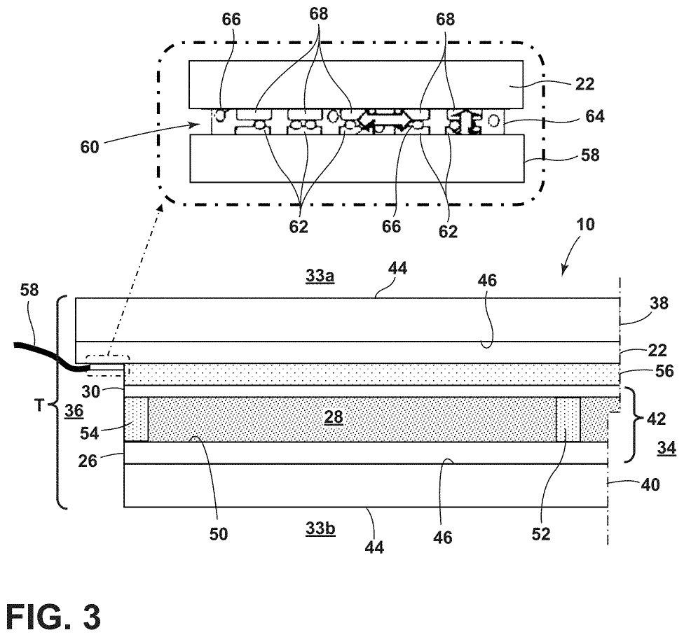

Referring more particularly to FIG. 3, the intermediate electrode 30 and the second electrode 26 define a cavity 50 extending therebetween for receiving the electro-optic medium 28. The electro-optic medium 28 may be an electro-optic fluid, gel, or solid layer of a substantially transparent material that is electrically conductive. According to at least one example, the electro-optic medium 28 is an electrochromic medium which includes at least one solvent, at least one anodic material, and at least one cathodic material. Typically, both of the anodic and cathodic materials are electroactive and at least one is electrochromic. The electrochromic material switches states between a transmission state that permits the transmission of various wavelengths of light and an operable state that reflects or absorbs the various wavelengths of light. The first and second electrodes 22, 26 may be surface-mounted to the inner surfaces 46 of the first and second substrates 38, 40, and may be solid, gelatinous, and/or the like. The intermediate electrode 30 may have the same or a similar composition to either or both of the first and second electrodes 22, 26. In some embodiments, the intermediate electrode 30 has a smaller thickness than first and second electrodes 22, 26. The composition of the electrodes 22, 26, 30 may be (indium tin oxide (ITO)) and/or other semi-transparent, electrically conductive materials. The electro-optic medium 28 may include an electrochromic substance that may alter in color when an electrical potential and/or an electric current is applied across the electro-optic medium 28. By employing selectively transparent materials in various components of the electro-optic device 10, the electro-optic device 10 may be selectively darkening (e.g., controlling the transmissivity of light via absorption or reflectance) depending on the electrical parameters applied to the electrodes 22, 26, 30.

With continued reference to FIG. 3, the cavity 50 may be sealed via one or more barriers 52, 54 disposed between the third electrode 30 and the second electrode 26. The barriers may include intermediate barriers 52 interposing multiple cavities 50, as well as end barriers 54. The end barriers 54 may be disposed along a periphery of the electro-optic device 10 to retain the electro-optic medium 28 and prevent the electro-optic medium 28 from being exposed to the negative impacts of environmental conditions (e.g., oxidization). The intermediate barriers 54 may physically and/or electrically isolate portions of the electro-optic medium 28 into multiple cavities 50. In this way, the intermediate barriers 52 may separate the electro-optic device 10 into a plurality of electro-optic elements 42, which may be controlled individually. In addition to providing improved control, the barriers 52, 54 may provide stability to the electro-optic device 10. The barriers 52, 54 may be formed of an epoxy resin and may be electrically nonconductive.

With continued reference to FIGS. 2 and 3, the switching circuitry 32 may be positioned in a switching layer 56 interposing the intermediate electrode 30 and one or both of the first electrode 22 and the second electrode 26. As depicted, the switching layer 56 may be sandwiched between the first electrode 22 and the intermediate electrode 30. Effectively, the switching layer 56 may control when and how much electrical power is supplied to the intermediate electrode 30 by adjustment of the switching circuitry 32. The switching layer 56 may have a similar shape and continuity as the backplane electrodes (e.g., the first electrode 22 and the second electrode 26), though the particular shape and distribution of the switching layer 56 may vary. For example, the switching layer 56 may be limited to one or more localized regions of the electro-optic device 10. For example, the switching layer 56 may be web-shaped, formed only along the side edges 49, or formed within a central region of the electro-optic element 42.

Referring to FIG. 3, the electro-optic device 10 may include a flexible circuit 58 that selectively carries electrical signals between the electro-optic components and off-board circuitry. The flexible circuit 58 may be in electrical communication with the electro-optic device 10 via a conductive connection 60 having a plurality of conductors 62 electrically isolated from one another. The conductive connection 60 may include anisotropic conductive film (ACF) having an epoxy acrylic adhesive 64 and electrically conductive beads 66 suspended in the adhesive 64. The adhesive 64 may be nonconductive to electrically isolate the beads 66. The beads 66 may provide electrical communication between the plurality of conductors 62 and one or more conductive traces 68 in the electro-optic device 10. For example, the electro-optic device 10 may include conductive traces 68 disposed on or embedded in the first or second electrodes 22, 26, the switching layer 56, or another portion of the electro-optic device 10. In a more specific example, one conductive trace 68 may be disposed on the electrode(s) 22, 26, 30 for providing a global voltage VG to the first or second electrodes 22, 26 (e.g., ITO backplanes) to switch between states of the entire electro-optic device 10, and other conductive traces 68 may be formed within the switching layer 56 for connecting with the switching circuitry 32 (i.e., for individualized control of the electro-optic elements 42). In some embodiments, the flexible circuit 58 may allow electrical properties of the electro-optic device 10 to be controlled at a location spaced from the electro-optic components, such as a remote human-user-interface and/or automatic control system.

Referring now to FIG. 4, the electro-optic device 10 is schematically illustrated with control circuitry 70 in electrical communication with the electro-optic element 42. For purposes of clarity, the electro-optic device 10 may be referred to as having a visible portion 71a of the electro-optic device 10 (e.g., the portion visible to a user) and a concealed portion 71b (e.g., features outside of the portion visible to the user and/or otherwise concealed by the barriers 52, 54 and/or other concealing structures (e.g., glass frits, reflective or opaque structures). A dividing line 72 demonstrates one possible configuration of the position of the visible portion 71a relative to a position of the concealed portion 71b. The left side of the dividing line 72 may represent the concealed portion 71b and the right side of the dividing line 72 may represent the visible portion 71a. The specific position of the various components of the electro-optic device 10 may depend on size, shape, material, application, and/or level of light opacity of each component. For example, components with transparent, translucent, or transflective properties may be disposed within the portion visible to the user, whereas large and/or substantially opaque components may be positioned in the concealed portion 71b. In this way, the portion visible to the user of the electro-optic device 10 is not visibly depreciated to the user between states.

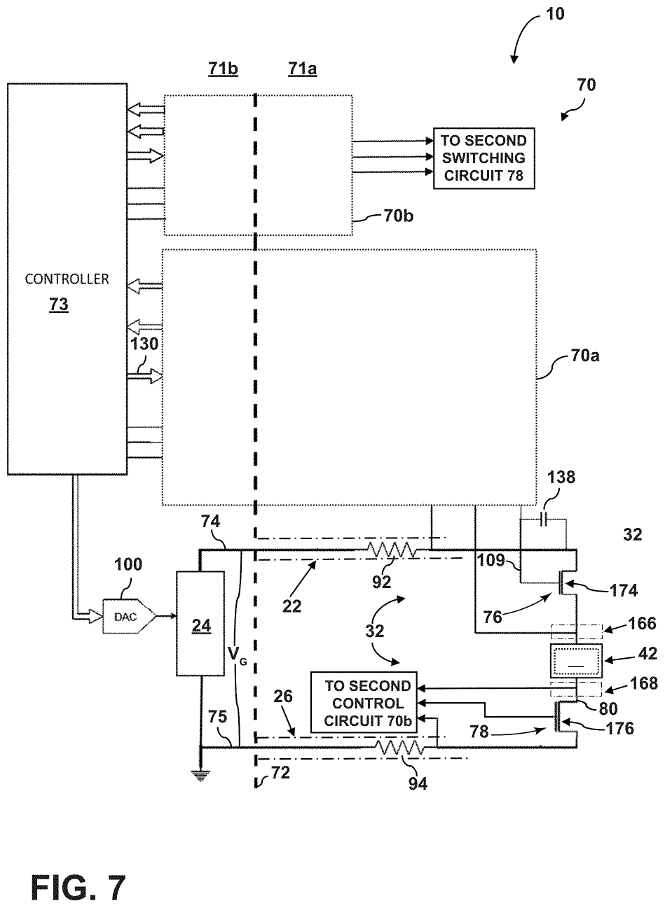

The control circuitry 70 generally achieves control of the electro-optic element 42 by controlling the power supply circuitry 24 and/or the switching circuitry 32. More specifically, the control circuitry 70 may include a controller 73 that receives voltage or current signals corresponding to voltages or currents associated with the electrodes 22, 26, 30. The controller 73 may be local to the electro-optic device 10 or remote and may be configured to only control functions of the electro-optic device 10 or control features of the electro-optic device 10 in addition to other features (e.g., in a vehicle). The controller 73 may generate and transmit control signals to the switching circuitry 32 and/or the power supply circuitry 24 to adjust a voltage or current applied to the electro-optic element 42. The control signals may be generated based on the voltage and current signals according to programmed instructions stored in the controller 73 (e.g., a memory in communication with the controller 73). For example, if a voltage between the intermediate electrode 30 and the second electrode 26 (i.e., the voltage across the electro-optic element 42) is less than a target voltage across the electro-optic element 42, the controller 73 may control the switching circuitry 32 to provide a greater voltage to the intermediate electrode 30. In this way, the voltage across the electro-optic element 42 may be increased to the target voltage. In examples described further herein, the controller 73 may control the switching circuitry 32 to provide a greater or lesser voltage to the second electrode 26 (e.g. FIG. 7).

As schematically represented in FIG. 4, the electro-optic element 42 may have a first electrical approximation of a resistor R in parallel with a resistor-capacitor (RC) series circuit. Though approximated as shown in FIG. 4, the electro-optic element 42 may also have a second electrical approximation of a current source in parallel with three parallel RC circuits. The second electrical approximation may be an accurate model when the electro-optic element 42 is an electrochromic cell (EC cell). For example, the EC cell may store more charge than a parallel plate capacitor. The electrical approximation of the electro-optic element 42 may depend on specific quantities and/or qualities of the materials employed in the electro-optic medium 28 (e.g., the electro-optic fluid), as well as the quality, and/or the type of materials forming the electrodes 22, 26, 30. Further, the electrical properties of the electro-optic element 42 may be transitory (e.g., dependent on the transmittance state or temperature of the electro-optic element 42). Additional factors that affect the operation of the electro-optic device 10 may include the age of the electro-optic device 10 or environmental conditions (e.g., temperature differential between an interior and an exterior of the vehicle). At least one temperature sensor may be provided with the electro-optic device 10 for monitoring the temperature of the electro-optic device 10. As will be described in further detail, the at least one temperature sensor may include a plurality of temperature sensors disposed in the electro-optic device 10 and/or about a perimeter of the electro-optic device 10. The at least one temperature sensor may include a band-gap voltage reference circuit or other circuitry operable to detect a temperature or temperature change associated with the electro-optic device 10.

With continued reference to FIG. 4, the electro-optic element 42 may be in communication with the power supply circuitry 24 via a first node 74 and a second node 75. The power supply circuitry 24 may be operable to apply the global voltage VG across the first node 74 and the second node 75. The power supply circuitry 24 may generate an electrical current to flow from the power supply circuitry 24 when a load (e.g., the electro-optic element 42) is in communication with both the first node 74 and the second node 75. To better control the current flow to/from the electro-optic element 42, the switching circuitry 32 may include a first switching circuit 76 that electrically interposes the first node 74 and a third node 77 electrically connected with the intermediate electrode 30. In this way, the switching circuitry 32 may selectively allow electrical current to flow between the first node 74 and the third node 77. In some examples described further herein, the switching circuitry 32 may also include a second switching circuit 78 that electrically connects a fourth node 80 that is electrically connected with the second electrode 26 to the power supply circuitry 24. As exemplarily illustrated in FIG. 4, the second switching circuit 78 may be omitted and electrical current through and/or voltage across the electro-optic element 42 may be controlled by the first switching circuit 76. This configuration may generally correspond to the “passive plate” arrangement previously described.

With continued reference to FIG. 4, at least one first resistor 92 is shown in electrical series connection with the first node 74 and at least one second resistor 94 is shown in electrical series connection with the second node 75. Each resistor 92, 94 serves as an electrical approximation of the inherent resistive properties of the first and second electrodes 22, 26, respectively. It is generally contemplated that, as the distance from the power supply circuitry 24 increases, the inherent resistance of the electrodes 22, 26 increases. This may result in a corresponding voltage drop across the length L or width of the electro-optic device 10. For example, the ITO may have a resistance of 1 ohm per square. Accordingly, the control circuitry 70 may monitor and control the electrical parameters of the electrodes (e.g., the first and second electrodes 22, 26), or areas near the electrodes, to maximize uniformity of the electro-optic device 10 between states.

Because the controller 73 may be a digital-signal controller, the control circuitry 70 may include at least one converter module 96, 98, 100, 102 for converting an electrical signal from one form to another form. For example, the controller 73 may be operable to output and receive digital signals, whereas the switching circuitry 32 and/or some portions of the control circuitry 70 may operate in response to analog signals (e.g., an electrical potential) and/or output analog signals. The converter modules 96, 98, 100, 102 may include a digital-to-analog converter (DAC) and an analog-to-digital converter (ADC). The ADC may be employed for monitoring various electrical parameters associated with the electro-optic device 10. For example, a first ADC 96 may be operable to receive a voltage measured via a first feedback node 104 in electrical communication with the first electrode 22. A second ADC 98 may be operable to receive a voltage measured via a second feedback node 106 in electrical communication with the intermediate electrode 30. A first DAC 100 may be employed to control the power supply circuitry 24, which may include one or more direct-current power supplies. It is generally contemplated that any other type of power supply may be employed to generate power for the electro-optic element 42, such as a current driving circuit, a voltage-driving circuit, etc. A second DAC 102 may be employed for controlling the switching circuitry 32 via first and second driving nodes 108, 109. The power supply circuitry 24 may be configured to set to a voltage lower than an element voltage (e.g., the voltage across the electro-optic element 42), for example, 0V or a negative voltage, to discharge the electro-optic element 42 and optically clear it from the darkened state. In this way, current flow through the electro-optic element 42 can be reversed, and charge may be removed from the electro-optic element 42.

The control circuitry 70 may include a plurality of control transistors 110, 112, 114 in electrical communication with the controller 73 via an integrated circuit (IC 116). A multiplexer 118 may interpose the controller 73 and the control transistors 110, 112, 114. Alternatively, the multiplexer 118 may be omitted and a select signal may be communicated directly to each of the control transistors 110, 112, 114 via one or more select nodes 119. In some embodiments, the IC 116 may operate as a DAC by processing one or more digital signals provided from the controller 73 to generate the select signal, which may be an analog signal, and communicate the select signal to the multiplexer 118 via a select node 119. The select signal may be controlled via a shift register that allows sequential selection of each output at a high frequency. The multiplexer 118 may be operable to output the control signal to one of the plurality of control transistors 110, 112, 114 via at least one control node 136 based on the select signal provided by the integrated circuit 116.

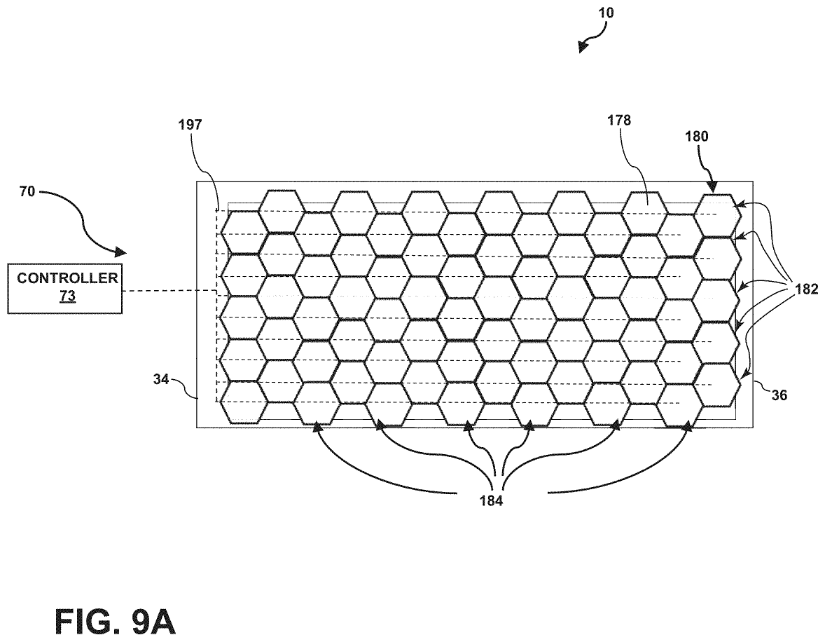

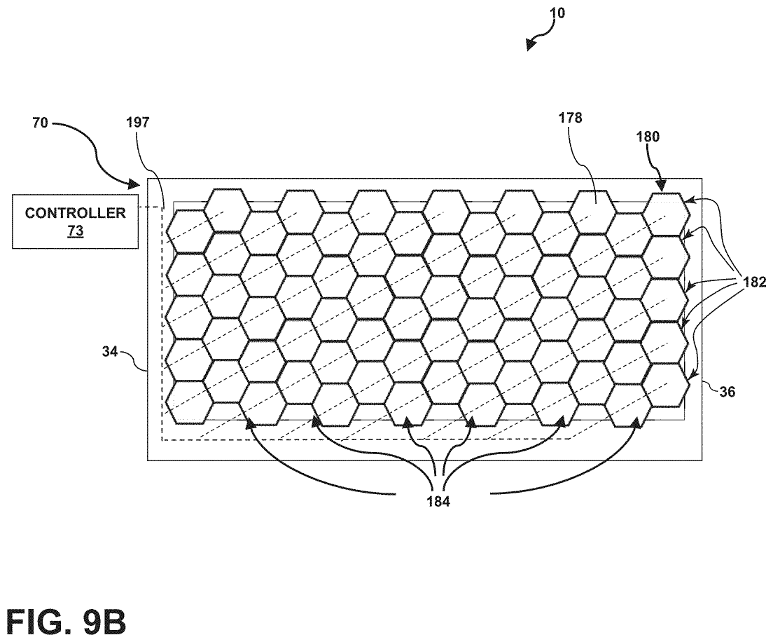

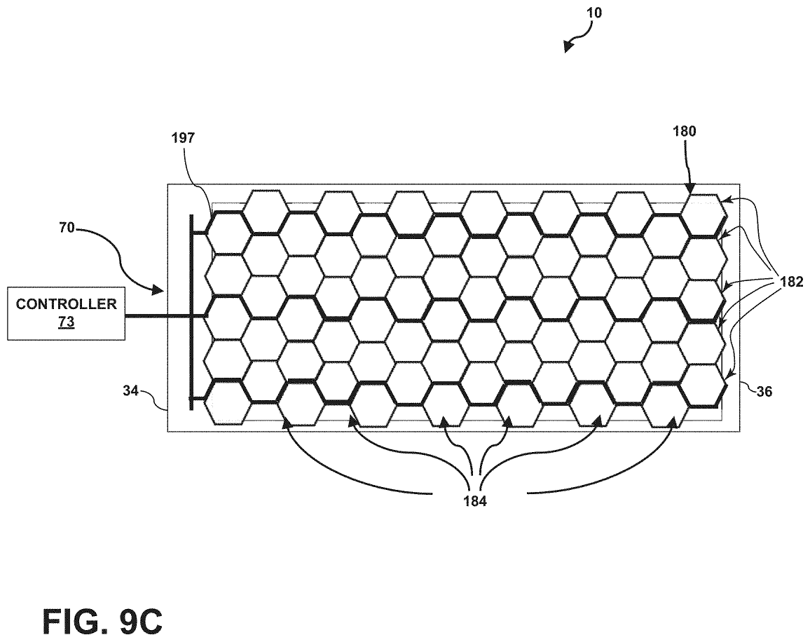

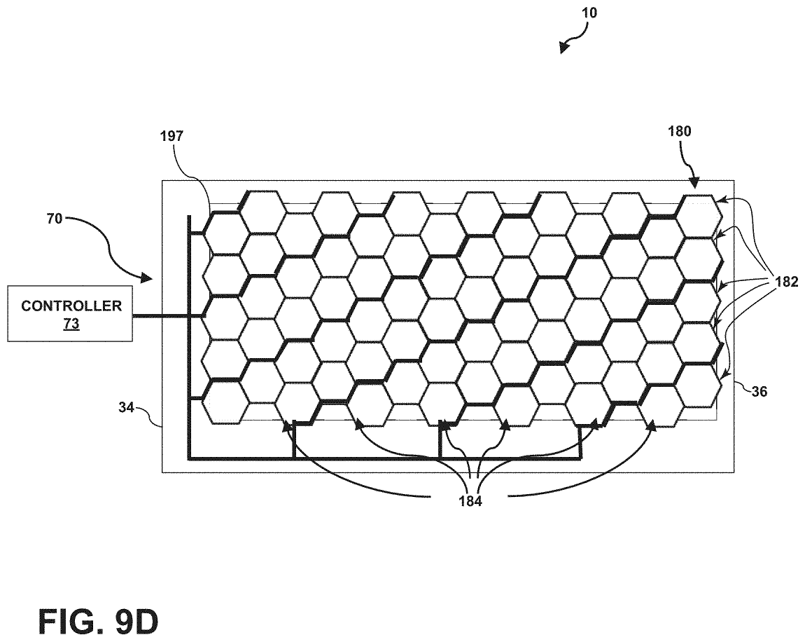

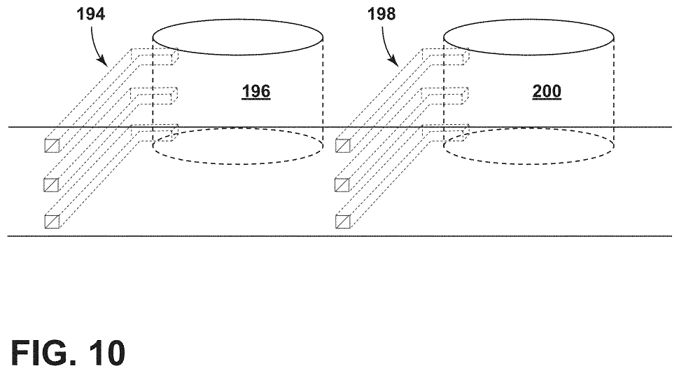

With continued reference to FIG. 4, in some embodiments, the integrated circuit 116 may be a gate-driving circuit. The IC 116 may be a source driver IC 116 (e.g., Novatek NT39411) to directly control a driving transistor 120 instead of the second DAC 102. As described in further detail in reference to FIGS. 8A-13, the source driver IC 116 may have multiple outputs to selectively actuate one or more electro-optic segments. The IC 116 may be mounted on the visible portion 71a (as illustrated) or the concealed portion 71b. The IC 116 may include at least 2000 digital-to-analog outputs for controlling a multitude of electro-optic elements 42 to monitor/control a multitude of points along a single electro-optic element 42. For example, the IC 116 may include a plurality of select nodes 119, with each select node 119 associated with one electro-optic element 42. In this way, the IC 116 may control hundreds, thousands, or more electro-optic elements 42 within the electro-optic device 10 (or, as discussed in reference to FIG. 9, hundreds, thousands, or more electro-optic segments). One output (e.g., the select signal) may control the multiplexer 118, which, in turn, is capable of controlling the plurality of control transistors 110, 112, 114. It is generally contemplated that one or more of the functions of the multiplexer 118 may be integrated into the IC 116. Alternatively, the features of one or both of the IC 116 and the multiplexer 118 may be integrated with the controller 73, such that the controller 73 may directly control the switching circuitry 32 without the need for additional components. The IC 116 may include one or more shift registers to allow the IC 116 to cycle between control commands of outputs of the IC 116.

With still continued reference to FIG. 4, the first control transistor 110 may interpose the first feedback node 104 and the first electrode 22. This arrangement may allow selective connection of the first feedback node 104 with the second electrode 26. The second control transistor 112 may interpose the second feedback node 106 and the intermediate electrode 30 for selectively connecting the second feedback node 106 with the intermediate electrode 30. The third control transistor 114 may interpose the first and second driving nodes 108, 109 for controlling the first switching circuit 76 to electrically connect the second electrode 26 with the third electrode 30. The first and second control transistors 110, 112 may be operable to transfer analog signals between the controller 73 and the first electrode 22, and between the controller 73 and the intermediate electrode 30, respectively. Further, the third control transistor 114 may be operable to transfer a digital signal between the controller 73 and the first switching circuit 76.

In some embodiments, the control circuitry 70 may dictate switching between states of the electro-optic element 42 by activating or deactivating the driving transistor 120 of the switching circuitry 32. The driving transistor 120 may interpose the first electrode 22 and the intermediate electrode 30. The driving transistor 120 may operate as a switch that, when opened (e.g., the driving transistor 120 being deactivated), precludes electrical current from flowing between the first electrode 22 and the intermediate electrode 30. When the switch is closed (e.g., the driving transistor 120 is activated), electrical current may flow between the first electrode 22 and the intermediate electrode 30 to darken the electro-optic element 42. The electro-optic element 42 may clear when electrical current is no longer applied to the electro-optic medium 28. Likewise, the electro-optic element 42 may darken when electrical current is applied to the electro-optic medium 28.

With continued reference to FIG. 4, the driving transistor 120 may have a first leg 122, a second leg 124, and a third leg 126. The third leg 126 may be operable to control electrical current between the first leg 122 and the second leg 124. The first leg 122 may be electrically connected with the first electrode 22, and the second leg 124 may be electrically connected with the intermediate electrode 30. The driving transistor 120 may be a field-effect transistor (FET) having a source terminal corresponding to the first leg 122, a drain terminal corresponding to the second leg 124, and a gate terminal corresponding to the third leg 126. The FET may be a Junction Field Effect Transistor (JFET), an Organic Field Effect Transistor (OFET), or a Metal Oxide Semiconductor Field Effect Transistor (MOSFET) and may be controlled depending on the voltage across the drain and the source terminals. Alternatively, the driving transistor 120 may be an insulated-gate bipolar transistor (IGBT). The driving transistor 120 may be a bipolar-junction transistor (BJT) having a collector terminal corresponding to the first leg 122, an emitter terminal corresponding to the second leg 124, and a base terminal corresponding to the third leg 126. The BJT may be an NPN transistor or a PNP transistor and may be controlled depending on the voltage across the base terminal and the emitter terminal. It is generally contemplated that the operation of the driving transistor 120 may be described with respect to an electrical current flowing through and/or a voltage corresponding to the third leg 126, and that reference to either type of transistor as “current-controlled” or “voltage-controlled” is merely descriptive and is non-limiting.

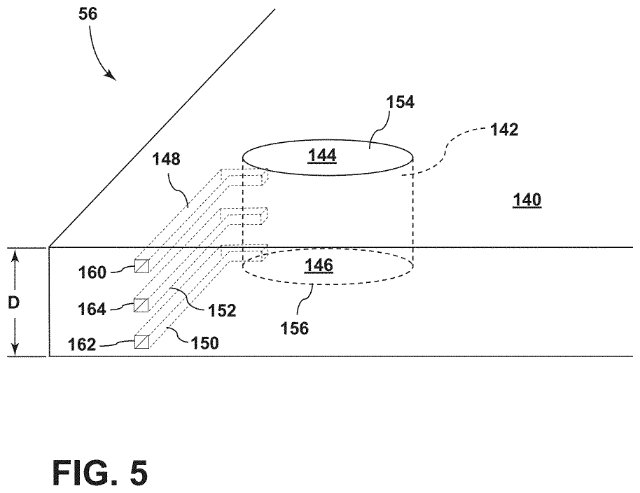

In some embodiments, the driving transistor 120 and/or the plurality of control transistors 110, 112, 114 are configured as thin-film transistors (TFTs) disposed in the visible portion 71a. For example, the switching layer 56 may include the driving transistor 120 and/or the plurality of control transistors 110, 112, 114. The transistors 110, 112, 114, 120 may be substantially transparent and/or may comprise visible metal tracings interconnecting with the intermediate electrode 30 (FIG. 5). In some embodiments, the metal tracings are visibly undetectable from a distance (e.g., 15-50 cm) away from the electro-optic device 10. Accordingly, one or more of the transistors 110, 112, 114, 120 may be provided on the visible portion 71a without negatively impacting the user's view.

With continued reference still to FIG. 4, the third leg 126 of the driving transistor 120 may be in electrical communication with the third control transistor 114 via the second driving node 109. In this way, control of the driving transistor 120 may derive from the controller 73. In operation, the controller 73 may communicate a first digital signal via a first output node 130. The first digital signal may be converted to a voltage or current via the second DAC 102. The controller 73 may further be operable to communicate a second digital signal to the IC 116 via a second output node 132. The second digital signal may cause the IC 116 to output a select signal to the multiplexer 118 via the select node 119. The select signal may cause the multiplexer 118 to output a control signal to the third control transistor 114 via the control nodes 136. The control signal may be an analog signal operable to control the third control transistor 114 to generate a voltage at the third leg 126 of the driving transistor 120 and/or allow current to flow from the second DAC 102, through the first and second driving nodes 108, 109, to the third leg 126 of the driving transistor 120. In this way, the controller 73 may be operable to control the driving transistor 120 to apply a current or voltage to the electro-optic element 42.

The voltage/current at the third leg 126 of the driving transistor 120 may cause the driving transistor 120 to allow current to flow from the first leg 122 (corresponding to the second electrode 26) to the second leg 124 (corresponding to the intermediate electrode 30). The first and second control transistors 110, 112 may operate similarly to the third control transistor 114. For example, the first control transistor 110 may operate to provide voltage and/or current measurement data to the controller 73 corresponding to the first electrode 22. The second control transistor 112 may operate to provide voltage and/or current measurement data to the controller 73 corresponding to the intermediate electrode 30. The measurement data may be a result of processing analog signals via the first and second ADCs 96, 98. According to some embodiments, the controller 73 may have direct control of the driving transistor 120. For example, the second DAC 102 may be operable as a simple source driver for the driving transistor 120 such that the third control transistor 114 is omitted. It is generally contemplated that both a gate driver IC 116 and a source driver IC 116 may be employed simultaneously. Either or both of the gate and source driver IC 116 may be a display driver integrated circuit (DDIC).

To maintain, or hold, the target voltage or a target current for the electro-optic element 42, a capacitor 138 may be provided with the electro-optic device 10. For example, after the electro-optic element 42 or a plurality of electro-optic segments is scanned and reference voltages are monitored/measured by the control circuitry 70, the capacitor 138 may provide a sample-and-hold function. In one example, the capacitor 138 stores an analog voltage during a scan of voltages across multiple electro-optic segments and/or while the controller 73 processes voltage data to control the DAC 102. The capacitor 138 may interpose the second electrode 26 and the second driving node 109 to control a voltage across and/or current between the first electrode 22 and the second driving node 109. For example, the capacitor 138 may charge and/or discharge current based on a voltage difference between the second driving node 109 and the first electrode 22. In operation, the capacitor 138 may hold a voltage of the gate terminal (i.e., the third leg 126) of the driving transistor 120 while the multiplexer 118 cycles through control of the control nodes 136. Stated differently, the capacitor 138 may allow the driving transistor 120 to remain activated after an analog signal of the second driving node 109 is removed by discharging its electrical energy once an electrical potential is removed from the capacitor 138.

Still referring to FIG. 4, the driving transistor 120 may be activated/deactivated at a particular frequency at an average activation time, thereby resulting in an average current or voltage to the third leg 126 at a particular rate. The controller 73, or another portion of the control circuitry 70, may be operable to apply pulse-width modulation (PWM) to the third leg 126 of the driving transistor 120. For example, the multiplexer 118 may be operable to pulse the third control transistor 114 on/off at a particular rate while the first driving node 108 maintains a constant signal/voltage. In this way, the driving transistor 120 may be selectively activated at a frequency that matches or otherwise corresponds to the frequency at which the third control transistor 114 is activated. The first node 74 may provide a relatively high voltage (e.g., between 0.8V and 6V), such that a duty cycle of the driving transistor 120 is operable to control a voltage applied to the intermediate electrode 30 of between 0V and 6V. For example, a 50 percent duty cycle may result in a voltage of 3V provided through the driving transistor 120. Due to the resistance of the electrodes 22, 26, 30 (e.g., ITO of the backplane and the resistors 92, 94), however, a drop in voltage may result in the same duty cycle (i.e., 50%) producing a voltage lower than 3V.

In some embodiments, the driving transistor 120 may be controlled to achieve a voltage drop across the electro-optic element 42 of between 0.2 and 0.8V. More particularly, the resistances of the first and second electrodes 22, 26 may be monitored or otherwise factored into a previously-programmed algorithm dictating functionality of the controller 73. For example, because there may be some loss of power along the ITO backplanes (e.g., the first and second electrodes 22, 26), the rate at which the driving transistor 120 is activated may be different depending on environmental conditions, such as heat, sunlight, and/or activation of one or more other circuits of the electro-optic device 10. The update rate of the control circuitry 70, or the frequency at which the controller 73 receives data and generates outputs, may be 10 Hz in some examples. The individualized control of the electro-optic element 42 may allow the electro-optic element 42 to not exceed a threshold voltage drop (e.g., 1.2V or 1.4V). The driving transistor 120 may employ amorphous silicon in order to limit leakage of the driving transistor 120 when light passes through the electro-optic device 10.

Due to the resistive nature of the ITO coating, electrical potential corresponding to the electrodes (e.g., the first, second, and intermediate electrodes 22, 26, 30) may decrease as the size of the electro-optic device 10 (e.g., length L, thickness, width, etc.) increases and/or the distance from the power supply circuitry 24 for the electro-optic device 10 increases. In general, a voltage drop across a distance from the power source may be approximated by half of a product of (i) a square of a distance from the electrical connector 48 (e.g., the busbar), (ii) a resistance value of the ITO coating per unit distance, and (iii) a loss of electrical current per area of the electro-optic element 42. Due to the quadratic relationship of voltage drop to the distance from the bus bar (e.g., the length L), increasing the distance by a factor (e.g., 2) results in a voltage drop of a square of that factor (e.g., 4). Thus, monitoring the voltage at several points along the electrodes (e.g., the first, second, and intermediate electrodes 22, 26, 30) may allow the controller 73 to individually control each driving transistor 120 of the electro-optic element 42 to achieve uniformity.

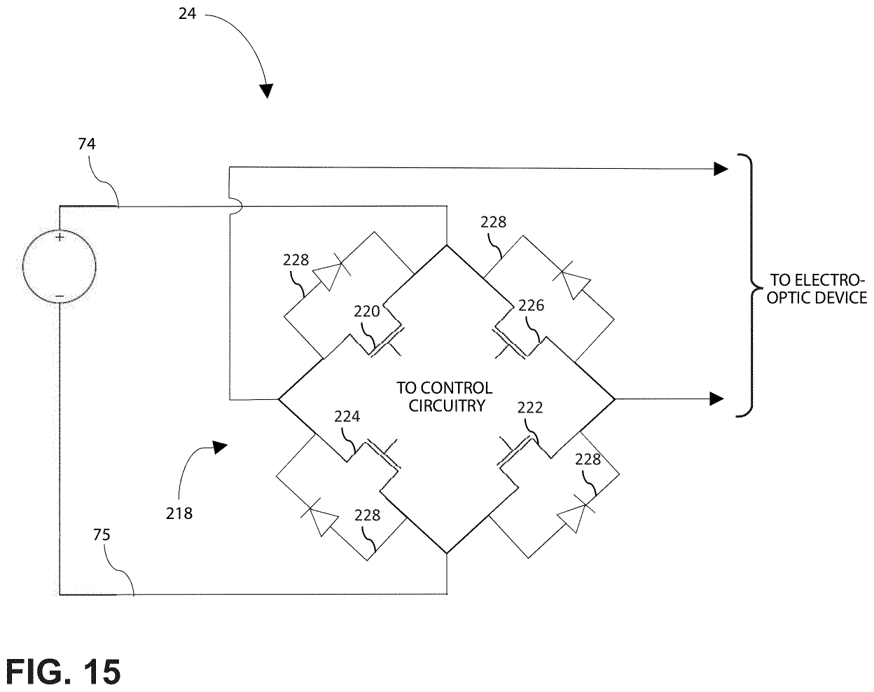

In some embodiments, the controller 73 may be operable to carry out various methods of controlling current through the electro-optic element 42. The controller 73 may include a processor and a memory (not shown). The memory may include instructions that, when executed by the processor, cause the processor to, at least, perform the functions associated with the components of the electro-optic device 10. The processor may include any suitable number of processors and the memory may comprise a single disk or a plurality of disks (e.g., hard drives), and includes a storage management module that manages one or more partitions within the memory. The memory may include Random Access Memory (RAM), a Read-Only Memory (ROM), or a combination thereof. The controller 73 may be operable to receive electrical feedback (e.g., voltage, current, etc.) corresponding to one or more of the first electrode 22, the second electrode 26, and the intermediate electrode 30. The controller 73 may be configured (e.g., via instructions contained in the memory) to control the switching circuitry 32 via the integrated circuit 116 and/or other control circuitry 70 based on the electrical information/feedback. In particular, the controller 73 may be operable to control the driving transistor 120 to pass current through the driving transistor 120 to activate the electro-optic element 42. The controller 73 may further be operable to control the power supply circuitry 24 based on the electrical information. By way of example, the controller 73 may control the power supply circuitry 24 to invert a polarity of the power supply circuitry 24 to cause an electrical current to flow from the second electrode 26 to the first electrode 22. One example of a power inverter circuit described further herein is illustrated in FIG. 15. Additionally, or alternatively, the controller 73 may control the power supply circuitry 24 to reduce an output voltage of the power supply circuitry 24.

Controlling current through the electro-optic element 42 may be a closed-loop operation due, in part, to the feedback nodes 104, 106. By monitoring the voltages and/or currents at various points within the electro-optic device 10, control of the switching circuitry 32 (e.g., the driving transistor 120) may be tailored to achieve desired characteristics of an electro-optic cell (e.g., electro-optic element 42). In examples incorporating the at least one temperature sensor, a temperature gradient of the electro-optic device 10 may be monitored by the control circuitry 70 to allow further individualized control of the electro-optic element 42 or multiple electro-optic segments. In some examples, by employing a voltage across the electro-optic element 42 to be within the range of approximately 0.2 volts and 0.8 volts, the transparency of the electro-optic medium 28 may be controlled. Continuing with this example, generating a 0.8 volt signal may cause the electrochromic fluid in the electro-optic medium 28 to darken, and a 0.2 volt signal may cause the electrochromic fluid in the electrochromic medium 28 to become clear. Due to the size and shape of the electrodes 22, 26, 30, as well as the location of where the voltage and/or current is applied, a gradient distribution of the electro-optic medium 28 may be provided. Further, as previously discussed, the thickness of the ITO may impact the resistance of the ITO and thus the voltage and/or current across the electro-optic element 42. According to some aspects, the thickness of the ITO may be approximately 1500 nm. In other configurations, the thickness of the ITO may be in the range of approximately 100 nm to approximately 250 nm thick.

Closed-loop voltage control may allow voltage variation across the ITO layers, thereby reducing sensitivity of the transistors to light and temperature variation. In other words, because changes of electrical properties (e.g., voltage) that result from light or temperature variation may be detected, power applied to the electro-optic element 42 may be controlled to not exceed a voltage or current capable of damaging the electro-optic element 42. In some examples, the driving transistor 120 may be deactivated for a period of time, and the feedback nodes 104, 106 may be monitored during the period of time. Because current may not flow through the electrodes (e.g., the first, and the intermediate electrodes 22, 30) while the voltage across the electro-optic element 42 is monitored (aside from a discharge of the capacitor 138), accurate voltage measurements may be gathered.

With reference now to FIG. 5, one possible position for the driving transistor 120 is generally indicated at the void shown (e.g., cavity 142). The cavity 142 may be generally cylindrically shaped. The driving transistor 120 and/or various electrical components of the switching circuit may be disposed in an insulating substrate 140 of the switching layer 56. The insulating substrate 140 may define the cavity 142 for receiving the switching circuitry 32. The cavity 142 may have an open top 144 and/or an open bottom 146, thereby extending through a depth D of the insulating substrate 140. The open top 144 may expose the cavity 142 to the first electrode 22, such that an electrically conductive material may extend between the first electrode 22 and at least a portion of the cavity 142. Similarly, the open bottom 146 may extend between the intermediate electrode 30 and at least a portion of the cavity 142. In this way, the switching circuit (for example, the driving transistor 120) may be in electrical communication with the second electrode 26 and the intermediate electrode 30. More specifically, the driving transistor 120 may be positioned adjacent the open top 144, and the second leg 124 of the driving transistor 120 may be positioned adjacent the open bottom 146. The insulating substrate 140 may be formed of a substantially transparent material, such as silicon dioxide.

With continued reference to FIG. 5, the insulating substrate 140 may include a plurality of electrode traces 160, 162, 164 to electrically connect portions of the cavity 142 with one or more electrical devices spaced from the electro-optic element 42. For example, the electrode traces 160, 162, 164 may be part of the control circuitry 70 and connect with one or more of the IC 116, the controller 73, the multiplexer 118, the control transistors 110, 112, 114, etc. from an exterior surface 153 of the switching layer 56, such as an outer edge of the electro-optic device 10. The plurality of electrode traces 160, 162, 164 may be fully enclosed by the insulating substrate 140, as illustrated, or may be disposed on upper and/or lower surfaces 154, 156 of the switching layer 56 (e.g., in a notch extending into the insulating substrate 140). The plurality of electrode traces 160, 162, 164 may include a first electrode trace 160, a second electrode trace 162, and a third electrode trace 164, each extending along non-intersecting pathways.

In some embodiments, the first electrode trace 160 may interconnect the first control transistor 110 and the second electrode 26. The second electrode trace 162 may interconnect the second control transistor 112 and the intermediate electrode 30. The third electrode trace 164 may interconnect the third control transistor 114 and the third leg 126 of the driving transistor 120. The plurality of electrode traces 160, 162, 164 may be formed of ITO or may be a metal wire or metal coating having a narrow width (e.g., between 0.1 micron and 1 mm), such that the electro-optic element 42 maintains substantial transparency. Although not illustrated in detail, the at least one temperature sensor may also be disposed in the insulating later 140 within the cavity 142 or a separate cavity. Additional electrode traces may be included in the electro-optic device 10 to allow electrical signals that carry voltage and/or current corresponding to temperature readings from the at least one temperature sensor to the control circuitry 70, for example, the at least one temperature sensor may be comprised of one or more TFT's to allow substantial transparency of the electro-optic device 10 while providing for individualized control based on a temperature gradient across the electro-optic device 10.

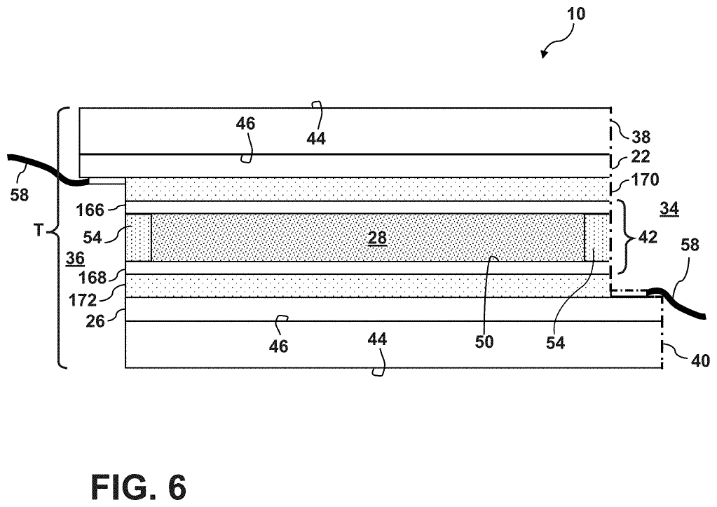

With reference now to FIGS. 6 and 7, an electro-optic device 10 of a second construction includes two active plates. More particularly, electro-optic device 10 in the second construction may include a first intermediate electrode 166 and a second intermediate electrode 168, or a plurality of intermediate electrodes 178 (FIG. 8A). Each of the plurality of intermediate electrodes 178 may be electrically isolated from other ones of the intermediate electrodes 178. The electro-optic medium 28 may be disposed between the first and second intermediate electrodes 166, 168. In this arrangement, the pair of intermediate electrodes 166, 168 and the electro-optic medium 28 form the electro-optic element 42, rather than one intermediate electrode 30 and the first and the second electrode 22, 26 as demonstrated in the first construction. As illustrated, the electro-optic device 10 may include a first switching layer 170 sandwiched between the first electrode 22 and the first intermediate electrode 166. A second switching layer 172 may be sandwiched between the second electrode 26 and the second intermediate electrode 168. Similar to the single switching layer 56, the first and second switching layers 170, 172 may include the features described as part of the switching layer 56 (i.e., the switching circuits 76, 78, the driving transistors 120, etc.).

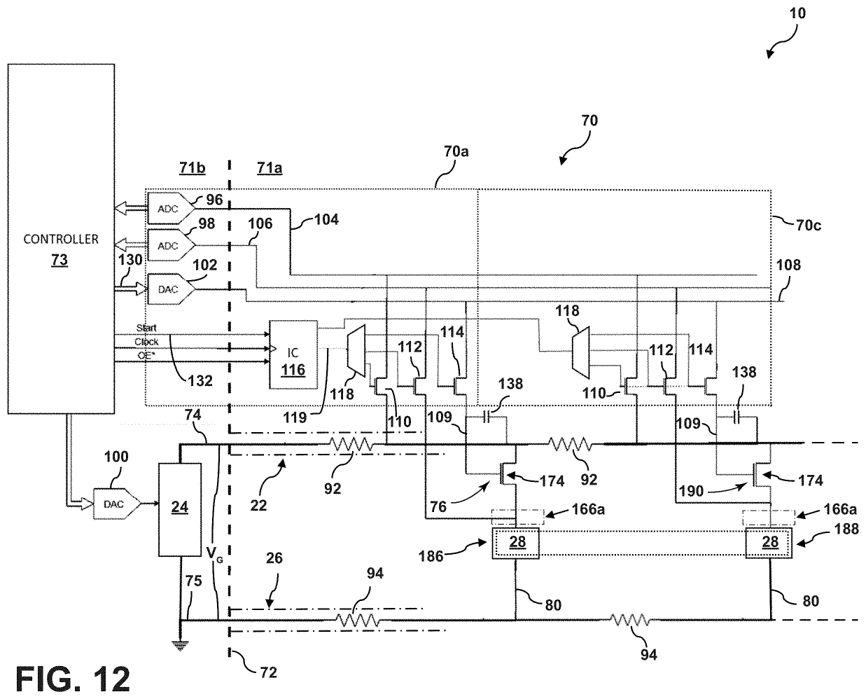

As illustrated particularly in FIG. 7, the switching circuitry 32 may include a first driving transistor 174 and a second driving transistor 176 (e.g., two or more driving transistors 120). The first driving transistor 174 may be operable to control an electrical connection between the first electrode 22 and the first intermediate electrode 166. The second driving transistor 176 may be operable to control an electrical connection between the second electrode 26 and the second intermediate electrode 168. The first and second switching circuits 76, 78 may be controlled via the same control circuitry 70 or separate control circuits (i.e., first and second control circuits). The first and second control circuits are indicated generally at 70a and 70b in FIG. 7. Though demonstrated as separate components, the first and second control circuits 70a, 70b may be implemented as a single control device (e.g., IC 116 in FIG. 12). By way of example, each of the control circuits 70a, 70b may include a combination of the previously-described electrical components, such as an IC 116, the multiplexer 118, and control transistors 110, 112, 114. The first and second control circuits 70a, 70b may be independently controlled by the controller 73. In this way, the controller 73 may control the first control circuit 70a in a different way than the second control circuit 70b. For example, the second driving transistor 176 may be controlled to pulse at a lower rate or a higher rate than the first driving transistor 174, or vice versa.

Providing the second switching layer 172 may allow for finer control of electrical potential, and thus electrical current, across the electro-optic element 42. Because the state of the electro-optic element 42 may depend on the relative voltage of the first intermediate electrode 166 and the second intermediate electrode 168, monitoring the voltage on either or both sides of the electro-optic element 42 may allow the controller 73 to provide more accurate responses. Further, inclusion of the second driving transistor 176 may provide even greater precision in achieving a desired current flow or voltage change.

Referring now to FIGS. 8A-13, various embodiments of the electro-optic device 10 include at least one electrode 178 (e.g. a plurality of intermediate electrodes 178) and at least one electro-optic segment 179 (e.g. a plurality of electro-optic segments 179). In some embodiments, the electro-optic device 10 includes a plurality of intermediate electrodes 178 and a plurality of electro-optic segments 179, each forming part of an electro-optic element 42. In some embodiments, the electro-optic device 10 includes a plurality of intermediate electrodes 178 and a single electro-optic segment 179, together forming part of an electro-optic element 42. In some embodiments, electro-optic device 10 includes a single intermediate electrode 178 and a plurality of electro-optic segments 179, together forming part of an electro-optic element 42.

While the intermediate electrodes 178 may be located between the first and second electrodes 22, 26, it should be appreciated that the intermediate electrodes 178 may replace one or both (e.g., via a pair of opposing intermediate electrodes 178a, 178b) of the first and second electrodes 22, 26. As such, “intermediate” or “third” electrodes as described herein may also be generally described as element electrodes. As will be described, the above embodiments may include a transistor array 180 with a series of conduction modules (e.g., thin-film transistors such as those previously designated numerals 110, 112, 114, and 120) that provide a current source to discrete locations in the at least one element electrode 178, which, in turn, provides current to the at least one electro-optic segment 179. More particularly, the transistor array 180 provides a pattern that locates transistors substantially uniformly across the electro-optic device 10 that, in operation, results in highly controlled discrete darkening of localized regions 177 with single or select transistors or overall darkening with each transistor based on operation of the switching circuitry 32.

With reference to FIG. 8A, the at least one intermediate electrode 178 is illustrated as including a plurality of intermediate electrodes 178 arranged in a variety of patterns (e.g. rows 182 and columns 184). In some embodiments, the intermediate electrodes 178 are hexagonal in shape forming a hexagonal lattice. However, it should be appreciated that in other embodiments, the intermediate electrodes 178 are rectangular, octagonal, decagonal, and/or the like in shape. The transistor array 180 includes at least one central transistor 180a and may further include a plurality of outer transistors 180b surrounding the central transistor 180a. Each transistor array 180 may be organized into transistor rows 181 and columns 183 (e.g. a hexagonal lattice). In operation, individual ones of the transistors 180a, 180b may result in a darkening of the localized regions 177. Generally speaking, these localized regions 177 expand in radially symmetric patterns when current is applied by the transistor 180a, 180b. The transistors 180a, 180b may be configured and function similar to the previously described control transistors 110, 112, 114.

With reference now to FIG. 8B, the at least one electro-optic segments 179 is illustrated as including a plurality of electro-optic segments 179. At least one (e.g., a plurality) of transistor arrays 180 may be arranged along each of the plurality of electro-optic segments 179. Each electro-optic segment 179 may include a peripheral edge 185 extending generally around a circumference. For example, the electro-optic segments 179 may be shaped as a perfect circle with a non-varying radius. In some embodiments, the circle may be an imperfect circle with a varying radius. For example, an imperfect circle may include one or more disruptions that deviate from the circumference (e.g. an icosagon, a peripheral edge 185 with one or more ripples, tails, depressions, and/or the like). As used herein, the term “perfect circle” means a shape that extends entirely around a circumference with a non-varying radius. However, it should be appreciated that a perfect circle may include negligible variation as a result of production limitations. It should also be appreciated that the electro-optic segments 179 may comprise other shapes, like rectangular, hexagonal, and/or the like. The electro-optic segments 179 may include a segment center 187, for example, the segment center 187 may be generally equidistant from or otherwise generally central from the peripheral edge 185. A central region 189 may surround the segment center 187. The central region 189 may be extended around the center 187 towards the peripheral edge 185 and be confined within 80% of an area of the electro-optic segment 179, for example, 60% or less, 50% or less, 40% or less, 30% or less, 20% or less, or 10% or less. In some embodiments, at least one of the transistors 180a, 180b may be aligned with the segment center 187 and/or central region 189. The plurality of electro-optic segments 179 may be arranged in a plurality of groups, wherein each of the plurality of groups defines a segment array 191 that includes a central electro-optic segment 179 and outer electro-optic segments 179. Each segment array 191 may be organized into rows 193 and columns 195 (e.g. a hexagonal lattice or grid). It should be appreciated that each electro-optic segment 179 may include a plurality of transistor arrays 180 within the peripheral edge 185.

With reference now to FIG. 8C, the at least one electro-optic segments 179 may include a single electro-optic segment 179 and a plurality of transistor arrays 180 may be arranged along the single electro-optic segment 179 and a single intermediate electrode 178 (e.g., electrodes 178a, 178b). As explained, the localized regions 177 may expand in radially symmetric patterns (e.g. circles) to a substantially darkened state where at least one localized region 177 contacts at least one adjacent localized region 177 (e.g., with a high voltage as described herein) but has yet to overlap. It should be appreciated that in a fully darkened state, the localized regions 177 may begin to or completely overlap.

With reference now to FIG. 8D, spatial and relative size relationships of the localized regions 177 in the substantially darkened state are illustrated. In the substantially darkened state, the darkened localized regions 177 may have a radius “r” and the transistor array 180 may be generally defined as a hexagonal-shape that includes six sides having a length “L”. In some embodiments, the length L is twice the size as the radius r. In other embodiments, L is smaller than the radius r. The length L may be uniform or differing. In some embodiments, each localized region 177 in the substantially darkened state has an Area_{(circle)} (i.e. a surface area) defined by the following equation (1):

Area_{(circle)}=(π/4)(a)²

In accordance with the above equation (1), an Area_{(hexagon)} (i.e. a surface area) of the transistor array 180 may be determined by the following equation (2):

Area_{(hexagon)}=((3√3)/2)(a)²

In such an arrangement, the ratio of each localized region 177 in the substantially darkened state in equation (1) and apertures therebetween within the Area_{(hexagon)} is less than 2/10, for example less than 1/10 when each transistor 180a, 180b in the transistor array 180 are actuated. Similarly, in situations wherein each transistor 180a, 180b in the electro-optic device 10 is actuated, the area of the localized regions 177 compared to non-darkened regions (e.g. apertures therebetween) is less than 2/10, for example less than 1/10 across each (e.g. one or more) electro-optic segment 179.

With continued reference to FIG. 8D, outer transistors 180b may be located where sides of the hexagonal shape meet, such that there are six outer transistors 180b and one central transistor 180a. In embodiments with a plurality of electro-optic segments 179 (i.e., FIG. 8B) the outer electro-optic segments 179 may be organized such that a center 187 of each outer electro-optic segment 179 is similarly located where the sides of the hexagonal shape meet, such that there are six outer electro-optic segments 179 and one central electro-optic segment 179 in each segment array 191. It should be appreciated that the term hexagon, may refer to a perfect hexagon or an imperfect hexagon. A perfect hexagon may be defined as a hexagon with equal sides L, each extending at uniform relative angles. However, it should be appreciated that a perfect hexagon may include negligible variation as a result of production limitations. An imperfect hexagon may be defined as a hexagon with unequal sides and uniform angles, equal sides and non-uniform angles, or unequal sides and non-uniform angles.

With reference now to FIGS. 8E and 8F, in some embodiments, the transistor array 180 may further be defined by staggered rows 181 and uniform columns 183 (FIG. 8E), the transistor array 180 may be defined by uniform rows 181 and staggered columns 183 (FIG. 8F), or, more generally, the transistor array 180 may include transistors disposed in a hexagonal lattice. The distribution of the transistor arrays 180 may extend along a surface having a width (W) and a height (H). In FIG. 8E, the staggered rows 181 and uniform columns 183 may define upward projecting diagonal lines of transistors 180a, 180b in adjacent columns 183 indicated by the dashed line. The transistors 180a, 180b along the upward projecting diagonal line may extend along a 2:1 pitch or about a 27° angle. Stated another way, transistors 180a, 180b in each uniform column 183 may be spaced by a distance D, wherein transistors 180a, 180b in each adjacent uniform column 183 are aligned centrally along the distance D. In FIG. 8F, the uniform rows 181 and staggered columns 183 may define upward projecting diagonal lines of transistors 180a, 180b in adjacent columns 183 indicated by the dashed line. The transistors 180a, 180b along the upward projecting diagonal line may extend along a 1:2 pitch or about a 63° angle. Stated another way, transistors 180a, 180b in each uniform column 183 (FIG. 8E) may be spaced by a distance D, wherein transistors 180a, 180b in each adjacent uniform column 183 are aligned with one another. In this manner, transistors 180a, 180b in each row 181 may be spaced by a distance D, wherein transistors 180a, 180b in each adjacent uniform row 181 are aligned centrally along the distance D.

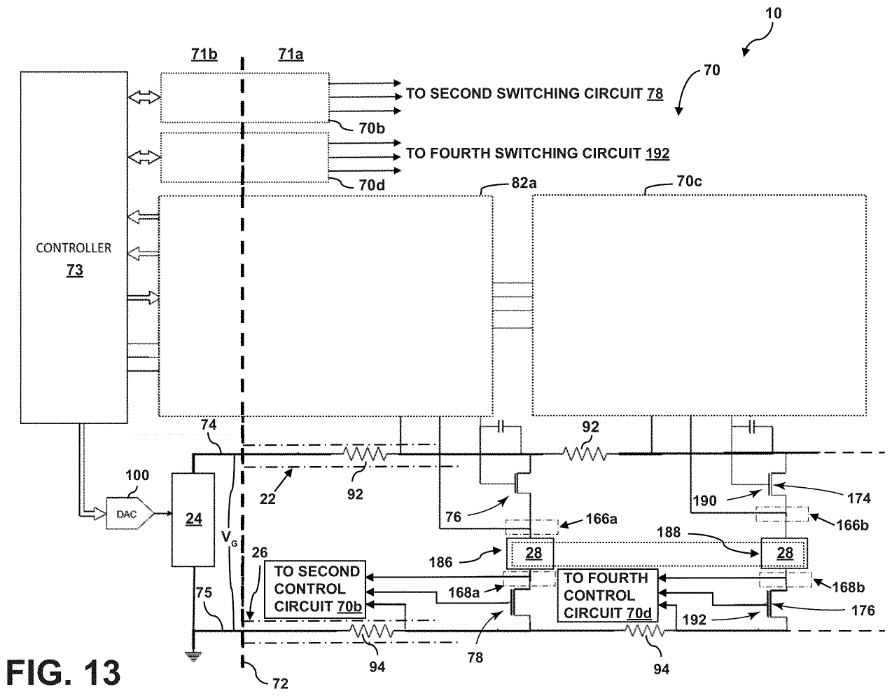

Both single-active plate (FIGS. 8A and 12) and dual-active plate (FIGS. 10 and 13) embodiments are illustrated employing the plurality of transistor arrays 180 as described herein. In embodiments with a plurality of electro-optic segments 179, barriers 52, 54 may be disposed therebetween. In embodiments with a single electro-optic segment 179, the intermediate barriers 52 may be omitted and the electro-optic segment 179 may be selectively darkened in localized regions 177 or completely darkened via employing current to each transistor 180a, 180b by operation of the switching circuitry 32. The transistor 180 array placement provides uniform and versatile power distribution globally or to specific ones of the localized regions 177.

As exemplarily illustrated in FIGS. 8A through 9D, the transistor array 180 may comprise a hexagonal lattice of any number of transistors 180a, 180b (e.g. over 1000, over 10,000, over 100,000, over or about 500,000, over or about 1,000,000). In this way, the desired transmissivity of individual portions (e.g., the localized regions 177) of the electro-optic element 42 may be controlled in order to create a desired shape and/or gradient of the electro-optic device 10. For example, it is generally contemplated from the present disclosure that the electro-optic device 10 may include any number (e.g., tens, hundreds, millions, etc.) of electro-optic segments 179 in a single electro-optic device 10, each aligned with at least one transistor 180a, 180b. The optical-spatial resolution of a shape formed by the at least one electro-optic segment 179 may be dependent on the number of electro-optic segment 179 and/or transistors 180a, 180b in the electro-optic device 10. Further, because the transistors 180a, 180b are in a hexagonal lattice (i.e. diagonal rows) that includes staggered rows 181 and/or columns 183, the traces for power, control, and sensing distribution (i.e., operational traces 197) may be simplified by allowing a larger area of incorporation. For example, FIGS. 9A and 9B illustrate operational traces 197 that includes portions that overlap with the electro-optic segments 179. In such embodiments, certain components of the operational traces 197 may be transparent, semi-transparent, opaque and/or small enough to not be easily perceived by a user. The operational traces 197 may extend between transistor arrays 180, for example, between individual transistors 180a, 180b. FIGS. 9C and 9D illustrate other embodiments, wherein the operational traces 197 generally follows intermediate barriers 52 or end barriers 54 of the at least one electro-optic segment 179 alternating between the rows and columns. The operational traces 197 may extend between transistor arrays 180, for example, between individual transistors 180a, 180b. It should be appreciated that the electro-optic segments 179 and the intermediate electrodes 178 may be stacked and uniformly distributed or different in size, shape, and distribution. In some embodiments, the operational traces 197 are configured as the electrode traces 160, 162, 164 previously described.

The size and shape of the electro-optic segments 179 may be uniform or non-uniform. For example, some electro-optic segments 179 may be shaped as a circle (e.g. a perfect circle, an imperfect circle, and/or the like) and other electro-optic segments 179 may be elongated and/or shaped as a regular polygon (e.g., a hexagon, a square), for example, around the visible borders of the electro-optic device 10. In some embodiments, one or more of the electro-optic segments 179 may form a curvilinear-shaped insignia, logo, or the like. In this way, the electro-optic device 10 may be operable to display an insignia by controlling the electro-optic medium 28 to transmit light within the insignia and block light outside of the insignia, or vice versa. Due to the difference in size and/or shape of the electro-optic segments 179 and or switching intermediate electrodes 178a and 178b in combination with the individualized control of the transistors 180a, 180b in the above described transistor arrays 180, a particular gradient or pattern may be formed in the electro-optic device 10.

Referring more particularly to FIGS. 9A through 10, portions of the control circuitry 70 may be positioned on one or both of the substrates 38, 40. For example, the power supply circuitry 24 and/or the control circuitry 70 (e.g., one or more of the converter modules 96, 98, 100, 102) may be positioned in the concealed portion 71b along the periphery of the electro-optic device 10. The power supply circuitry 24 and/or the control circuitry 70 may connect with the electro-optic segments 179 via sense and drive busses (generally illustrated by arrows in FIGS. 9A and 9B). The sense and drive busses may be provided via the electrode traces 160, 162, 164, as previously described. The electrode traces 160, 162, 164 may be formed in insulated portions of the switching layer 56 between the electro-optic segments 179. In this way, the electrode traces 160, 162, 164 may remain electrically isolated from all of the electro-optic segments 179 but a particular electro-optic segment 179 to be controlled/monitored via the control circuitry 70.

Referring to FIG. 10, a cross-sectional view of a portion of the electro-optic device 10 is illustrated showing a pair of side-by-side electro-optic segments 179 (e.g., a first electro-optic segment 186 and a second electro-optic segment 188). The first and second electro-optic segments 186, 188 may be spaced from one another. The optical transmissivity of the first electro-optic segment 186 and the second electro-optic segment 188 may be controlled individually to achieve a desired pattern or rate of clearing/darkening of the electro-optic device 10. It is generally contemplated that the first electro-optic segment 186 may be in parallel with the second electro-optic segment 188. Although a double active plate configuration is illustrated in the exemplary figure, it is generally contemplated that the electro-optic segments 186, 188 may be part of an electro-optic device 10 having a single active plate.

As similarly described with respect to the configuration having two intermediate electrodes 178a, 178b (e.g., the electrodes 166, 168) in a single electro-optic element 42 (e.g., FIG. 6), the first switching layer 170 may be disposed between the first electrode 22 and the pair of first intermediate electrodes 178a, 178b. The first switching layer 170 may include the first switching circuit 76 for controlling the first electro-optic segment 186. The first switching layer 170 may also include a third switching circuit 190 (see FIGS. 12 and 13) for controlling the second electro-optic segment 188. Similarly, the second switching layer 172 may be disposed between the second electrode 26 and the pair of second intermediate electrodes 178a, 178b. The second switching layer 172 may include the second switching circuit 78 for controlling the first electro-optic segment 186. The second switching layer 172 may also include a fourth switching circuit 192 for controlling the second electro-optic segment 188. Each of the switching circuits 76, 78, 190, 192 may be controlled as a group or individually by employing a combination of various electrical components previously discussed (e.g., controller 73, control circuitry 70, multiplexers 118, control transistors 110, 112, 114, ICs 116, DAC's 100, 102, ADC's 96, 98, etc.). These switching circuits 76, 78, 190, 192 are generally illustrated in FIG. 13.

Referring back to FIGS. 8A-9D, the one or more electro-optic segments 179 may form the segment array 191 of electro-optic segments 179 in a hexagonal lattice-like configuration, however, any shape and/or arrangement of the segment array 191 may be formed. For example, the segment array 191 may be arranged linearly having only one dimension (e.g., a single row). Alternatively, the segment array 191 may be irregular and/or form a grid that corresponds to an insignia. The array 191 depicted in the figures is a non-limiting arrangement of the segment array 191.

Control of one localized area 177 may impact the control of adjacent localized areas 177. For example, as a voltage associated with a first localized area 177 is adjusted, the voltage supplied to surrounding localized areas 177 may be changed as well. Thus, an oscillating feedback loop may be achieved, as the controller 73 may be operable to sample discrete time feedback signals associated with voltages of the localized areas 177. Stated differently, control of the driving transistors 180a, 180b may cause changes in voltages of neighboring localized areas 177 due to the common connection with the first and second electrodes 22, 26, the element electrodes 178, and the controller 73 may utilize this response to maximize uniformity. Because each localized area 177 is staggered and expands in the shape of a circle, uniform changes will occur. As such, any voltage received by neighboring localized areas 177 will be substantially uniform.

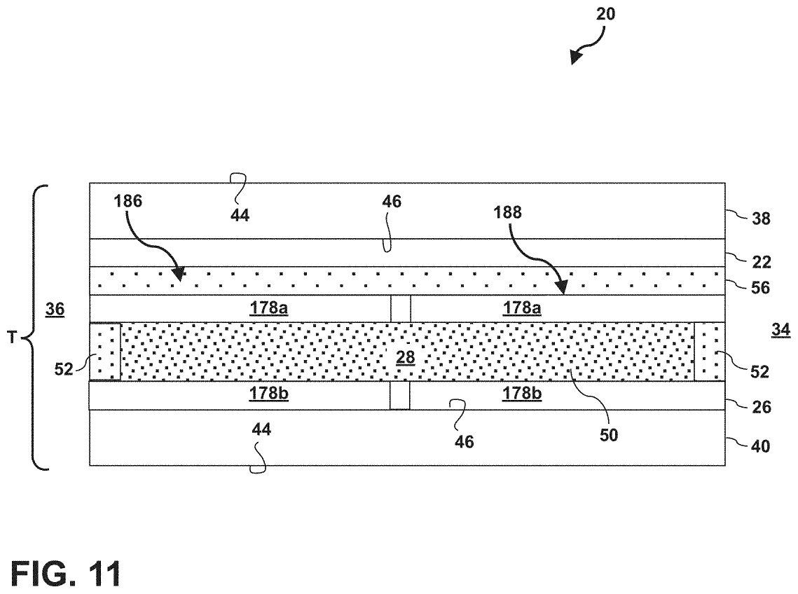

As previously described with respect to a single switching layer 56, switching layers 170, 172 may include the plurality of electrode traces 160, 162, 164 and define a cavity 142 associated with each switching circuit 76, 78, as shown in FIG. 11. Thus, each switching layer 170, 172 may include a first set of electrode traces 194 and a first cavity 196 corresponding to the first electro-optic segment 186. Each switching layer 170, 172 may also define a second set of electrode traces 198 and a second cavity 200 corresponding to the second electro-optic segment 188. Each of the cavities 196, 200 may be generally cylindrical in shape. It is generally contemplated that each set of electrode traces 194, 198 may include additional electrode traces to allow for dual active-plate control, general monitoring, and/or temperature monitoring. The first switching circuit 76 and the third switching circuit 190 may be disposed in the first cavity 196 and the second cavity 200 of the first switching layer 170, respectively. The second switching circuit 78 and the fourth switching circuit 192 may be disposed in the first cavity 196 and the second cavity 200 of the second switching layer 172, respectively. In some embodiments, the first and second electrode traces 194, 198 are configured as the electrode traces 160, 162, 164 previously described.

Referring now to FIGS. 12 and 13, configurations of the electro-optic device 10 having first and second electro-optic segments 186, 188 are illustrated. It is generally contemplated that any number of electro-optic segments 179 may be disposed in parallel with the electro-optic segments 186, 188, as indicated by the continuing of the first electrode 22 and the nodes past the second electro-optic segment 188. With reference to FIG. 12, the electro-optic device 10 is demonstrated with a single active plate, whereas FIG. 13 illustrates an electro-optic device 10 having two active plates. As illustrated in the figures, a third control circuit 70c may be provided to control the third switching circuit 190. As illustrated in FIG. 13, a fourth control circuit 70d may be provided to control the fourth switching circuit 192. It is generally contemplated that each control circuit 70a, 70b, 70c, 70d may be controlled by a single IC 116 via a select node for each control circuit. The configurations illustrated in FIGS. 12 and 13 demonstrate the scalability of electro-optic segments 179 in the electro-optic device 10. It is generally contemplated that a hybrid electro-optic device 10 having part dual and part single active plate configurations may be configured according to aspects of the present disclosure. Stated differently, in some configurations, the electro-optic device 10 includes two active plates associated with the first electro-optic segment 186 and one active plate associated with the second electro-optic segment 186.

In operation, the IC 116 may be employed to adjust the current into each segment, then the control loop may monitor the voltage and control the driving transistors 174, 176 to a desired set point. In this way, the second DAC 102 may continuously and directly drive each electro-optic segment 179. In a 0.5 m×1.0 m window assembly (e.g., a sunroof window), up to 1,000 electro-optic segments may be provided, each having a footprint of 1 square millimeter. Thus, resistance of the ITO backplanes may significantly impact the voltage/current of each segment over the length L or width W of the electro-optic device 10. Therefore, the controller 73 may be configured to incorporate voltage and current feedback/control to safely and uniformly control the electro-optic segments 179.

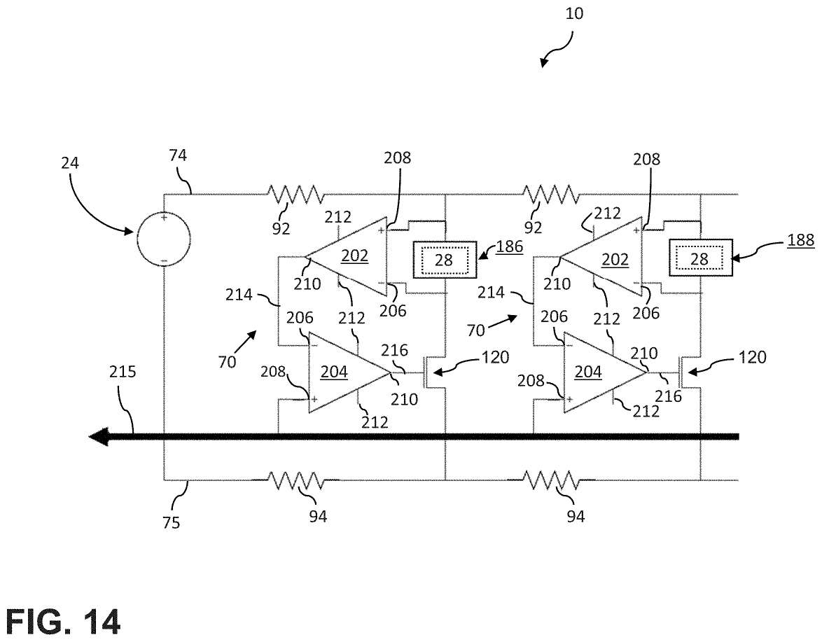

Referring to FIG. 14, one configuration of the electro-optic element 42 may include at least one operational amplifier 202, 204 operable to control one or more of the driving transistors 120 (e.g., driving transistors 174, 176). For example, each switching circuit (e.g., second and fourth switching circuits 78, 192) may include a first operational amplifier (op amp 202) in electrical communication with a second operational amplifier 204 downstream of the first op amp 202. Each op amp 202, 204 may include an inverting input terminal 206, a non-inverting input terminal 208, and an output terminal 210 that controls an output signal based on a voltage difference between the inverting input terminal 206 and the non-inverting input terminal 208. Further, each op amp 202, 204 may include two power inputs 212 to allow each op amp 202, 204 to amplify a signal supplied to the op amp. The first op amp 202 may be operable to receive a voltage difference of the first electrode 22 and the intermediate electrode 30. The second op amp 204 may be operable to receive a voltage difference of a first output 214 of the first op amp 202 and a voltage of a control signal node 215. The control signal node 215 may correspond to the first driving node 108 of the previous embodiments. A second output 216 of the second op amp 204 may be in electrical communication with the third leg 126 of the driving transistor 120.

In operation, a voltage of the control signal node 215 may effectively control the voltage across the electro-optic segments 186, 188. For example, the power supply circuitry 24 may output a high global voltage VG (e.g., 6V). The polarity of the global voltage VG may be reversed to enable faster clearing of the electro-optic device 10. Alternatively, a 4-transistor H-bridge 218 may be used to drive each individual electro-optic segment 186, 188 in either polarity (FIG. 15). For example, one H-bridge 218 may be associated with each of the pair of electro-optic segments 186, 188, and/or one H-bridge 218 may be employed to control the polarity of the global voltage VG, as illustrated. It is contemplated that the controller 73 may be configured to activate individually-controlled transistors (e.g., first transistors 220, 222) of the H-bridge 218 to provide a non-inverted power signal to the electro-optic device 10 (e.g., individual electro-optic segments 179) when second transistors 224, 226 of the H-bridge 218 are deactivated. Similarly, the controller 73 may be configured to activate the second transistors 224, 226 of the H-bridge 218 to provide an inverted power signal to the electro-optic device 10 when the first transistors 220, 222 are deactivated. A voltage protection circuit 228, such as the parallel diode circuit illustrated, may be incorporated with each of the transistors 220, 222, 224, 226 to prevent electrical shorts in the H-bridge 218 and/or the power supply. It is contemplated that the 4-transistor H-bridge 218 may be incorporated with any of the previously described configurations in addition to or as a replacement of control transistors 110, 112, 114.

One electrode of each electro-optic segment 186, 188 may be connected to the first node 74 of the power supply circuitry 24. The voltage of the control signal node 215 may be proportional to a difference between the global voltage VG and a target voltage across the electro-optic segments 186, 188. The second op amp 204 may then output a signal based on a difference between the target voltage of the control signal node 215 and the output voltage of the first op amp 202. Since the output voltage of the first op amp 202 may be proportional to a voltage across the electro-optic segments 186, 188, control of the global voltage VG may result in self-regulation (e.g., pre-configured voltage regulation of the electro-optic segments 179). Stated differently, according to some embodiments, the controller 73 may not require direct feedback to achieve adequate voltage control of the electro-optic element 42. In some configurations, the controller 73 may be omitted and the reference voltage provided by the control signal node 215 may be provided directly by the power supply circuitry 24.

The electro-optic element 42 and the first and second substrates 38, 40 may be formed of various materials. For example, the first and second substrates 38, 40 may include plastic materials. Plastic materials for the first and second substrates 38, 40 may include, but are not limited to, polycarbonates, polyethylene terephthalate (PET), polyesters, polyimides, polyamides, acrylics, cyclic olefins, polyethylenes (PE), like metallocene polyethylene (mPE), polyethylene naphthalate (PEN), silicones, urethanes, and various polymeric materials. The first and second substrates 38, 40 may also be of various forms of glass, including, but not limited to, soda lime float glass, borosilicate glass, boro-aluminosilicate glass, or various other compositions. When using glass substrates, the first and second substrates 38, 40 can be annealed, heat strengthened, chemically strengthened, partially tempered, or fully tempered. The electro-optic element 42 forming the panel (e.g., a window, viewing device, selective display device, etc.) may be supported by a frame, which may correspond to a partial or full frame that may be used to support a window panel as desired.

The first and second substrates 38, 40 as well as one or more protective layers, may be adhered together by one or more laminate materials. For example, the laminate material may correspond to at least one of the following materials: polyvinyl butyral (PVB), ethylene-vinyl acetate (EVA), thermoset EVA ethylene-vinyl acetate (EVA), and thermoplastic polyurethane (TPU). The specific materials are described in the disclosure and may correspond to exemplary materials that may be employed as laminate materials to adhere to one or more of the first and second substrates 38, 40 and/or additional protective layers or coating.

According to various aspects, the electro-optic element 42 may include memory chemistry configured to retain a state of transmittance when the vehicle and the window control module are inactive (e.g., not actively supplied energy from a power supply of the vehicle). That is, the electro-optic element 42 may be implemented as an electrochromic device having a persistent color memory configured to provide a current during clearing for a substantial time period after being charged. An example of such a device is discussed in U.S. Pat. No. 9,964,828 entitled “ELECTROCHEMICAL ENERGY STORAGE DEVICES,” the disclosure of which is incorporated herein by reference in its entirety.

The electro-optic element may correspond to an electrochromic device being configured to vary the transmittance of the window discussed herein in response to an applied voltage from the window. Examples of control circuits and related devices that may be configured to provide for electrodes and hardware configured to control the electro-optic element are generally described in commonly assigned U.S. Pat. No. 8,547,624 entitled “VARIABLE TRANSMISSION WINDOW SYSTEM,” U.S. Pat. No. 6,407,847 entitled “ELECTROCHROMIC MEDIUM HAVING A COLOR STABILITY,” U.S. Pat. No. 6,239,898 entitled “ELECTROCHROMIC STRUCTURES,” U.S. Pat. No. 6,597,489 entitled “ELECTRODE DESIGN FOR ELECTROCHROMIC DEVICES,” and U.S. Pat. No. 5,805,330 entitled “ELECTRO-OPTIC WINDOW INCORPORATING A DISCRETE PHOTOVOLTAIC DEVICE,” the entire disclosures of each of which are incorporated herein by reference.

Examples of electrochromic devices that may be used in windows are described in U.S. Pat. No. 6,433,914 entitled “COLOR-STABILIZED ELECTROCHROMIC DEVICES,” U.S. Pat. No. 6,137,620 entitled “ELECTROCHROMIC MEDIA WITH CONCENTRATION-ENHANCED STABILITY, PROCESS FOR THE PREPARATION THEREOF AND USE IN ELECTROCHROMIC DEVICES,” U.S. Pat. No. 5,940,201 entitled “ELECTROCHROMIC MIRROR WITH TWO THIN GLASS ELEMENTS AND A GELLED ELECTROCHROMIC MEDIUM,” and U.S. Pat. No. 7,372,611 entitled “VEHICULAR REARVIEW MIRROR ELEMENTS AND ASSEMBLIES INCORPORATING THESE ELEMENTS,” the entire disclosures of each of which are incorporated herein by reference. Other examples of variable transmission windows and systems for controlling them are disclosed in commonly assigned U.S. Pat. No. 7,085,609 entitled “VARIABLE TRANSMISSION WINDOW CONSTRUCTIONS,” and U.S. Pat. No. 6,567,708 entitled “SYSTEM TO INTERCONNECT, LINK, AND CONTROL VARIABLE TRANSMISSION WINDOWS AND VARIABLE TRANSMISSION WINDOW CONSTRUCTIONS,” each of which is incorporated herein by reference in its entirety. In other embodiments, the electro-optic device may include a suspended particle device, liquid crystal, or other system that changes transmittance with the application of an electrical property.

The invention disclosed herein is further summarized in the following paragraphs and is further characterized by combinations of any and all of the various aspects described therein.

According to one aspect of the disclosure, an electro-optic device includes a first substrate and a second substrate. A first electrode is coupled to the first substrate and a second electrode is coupled to the second substrate. An electro-optic medium is disposed between the first electrode and the second electrode and is configured to be electro-activated between states. A plurality of transistors are in electrical communication with the electro-optic medium to switch localized regions of the electro-optic medium between states.

According to another aspect of the disclosure, a plurality transistors form a plurality of transistor arrays disposed in rows and columns.

According to yet another aspect of the disclosure, each transistor array defines a hexagonal shape with six sides and a plurality of transistors in each transistor array includes outer transistors and a central transistor, where each of the outer transistors are located at a point where two sides of a hexagonal shape join and a central transistor that is located between the outer transistors.

According to another aspect of the disclosure, a central transistor is spaced equally from each of the outer transistors.

According to yet another aspect of the disclosure, a plurality of transistor arrays are staggered along the rows and uniformly aligned along the columns.

According to still another aspect of the disclosure, a plurality of transistor arrays are staggered along the columns and uniformly aligned along the rows.

According to another aspect of the disclosure, a plurality of operational traces extend between the transistor arrays and provide electricity to each of the plurality of transistors.

According to still another aspect of the disclosure, a plurality of operational traces extend in parallel lines.

According to yet another aspect of the disclosure, parallel lines are diagonal to the rows and columns.

According to another aspect of the disclosure, a plurality of operational traces follow a perimeter of the transistor arrays along one of the rows and columns.

According to yet another aspect of the disclosure, a plurality of operational traces follow a perimeter of the transistor arrays alternating between the rows and columns.

According to still another aspect of the disclosure, a plurality of intermediate electrodes is located between a first electrode and a second electrode and in contact with an electro-optic medium.

According to one aspect of the disclosure, a plurality of transistors are in electrical communication with an electro-optic medium through a plurality of intermediate electrodes.

According to yet another aspect of the disclosure, intermediate electrodes are electrically isolated from one another.

According to still another aspect of the disclosure, each of the intermediate electrodes are in selective electrical communication with one of a first electrode and a second electrode with a switching layer.

According to another aspect of the disclosure, an electro-optic device includes a first substrate and a second substrate. A first electrode is coupled to the first substrate and a plurality of intermediate electrodes are coupled to the second substrate. An electro-optic medium is disposed between the first electrode and the plurality of intermediate electrodes and is configured to be electro-activated between states. A plurality of transistor arrays are in electrical communication with the electro-optic medium through the plurality of intermediate electrodes to switch localized regions of the electro-optic medium between states.

According to yet another aspect of the disclosure, a second electrode is disposed between a second substrate and a plurality of intermediate electrodes.

According to still another aspect of the disclosure, each of the intermediate electrodes defines a hexagonal shape with six sides.

According to another aspect of the disclosure, each of the intermediate electrodes are disposed in rows and columns and one of the rows and columns are staggered.

According to yet another aspect of the disclosure, a plurality of transistor arrays each include a central transistor connected centrally to different ones of the intermediate electrodes.

According to yet another aspect of the disclosure, an electro-optic device includes a first substrate and a second substrate. An electro-optic medium is disposed between the first substrate and the second substrate and is configured to be electro-activated between states. A plurality of transistors are in electrical communication with the electro-optic medium to switch localized regions of the electro-optic medium between states. The plurality of transistors are disposed in a hexagonal lattice.

According to still another aspect of the disclosure, a plurality of operational traces extend between each of the transistors and a control system for individually providing power to each transistor.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. An electro-optic device comprising:
a first substrate;
a second substrate;
a first electrode coupled to the first substrate and a second electrode coupled to the second substrate;
an electro-optic medium disposed between the first electrode and the second electrode and electro-activated between states; and
a plurality of transistors in electrical communication with the electro-optic medium to switch localized regions of the electro-optic medium between states.

2. The electro-optic device of claim 1, wherein the plurality transistors form a plurality of transistor arrays disposed in rows and columns.

3. The electro-optic device of claim 2, wherein each transistor array defines a hexagonal shape with six sides and the plurality of transistors in each transistor array includes outer transistors and a central transistor, each of the outer transistors located at a point where two sides of the hexagonal shape join and the central transistor is located between the outer transistors.

4. The electro-optic device of claim 2, wherein the plurality of transistor arrays are staggered along the rows and uniformly aligned along the columns.

5. The electro-optic device of claim 2, wherein the plurality of transistor arrays are staggered along the columns and uniformly aligned along the rows.

6. The electro-optic device of claim 2, wherein a plurality of operational traces extend between the transistor arrays and provide electricity to each of the plurality of transistors.

7. The electro-optic device of claim 6, wherein the plurality of operational traces extend in parallel lines.

8. The electro-optic device of claim 7, wherein the parallel lines are diagonal to the rows and columns.

9. The electro-optic device of claim 6, wherein the plurality of operational traces follow a perimeter of the transistor arrays along one of the rows and columns.

10. The electro-optic device of claim 1, further including a plurality of intermediate electrodes located between the first electrode and the second electrode and in contact with the electro-optic medium.

11. The electro-optic device of claim 10, wherein the plurality of transistors are in electrical communication with the electro-optic medium through the plurality of intermediate electrodes.

12. The electro-optic device of claim 11, wherein the intermediate electrodes are electrically isolated from one another.

13. The electro-optic device of claim 11, wherein each of the intermediate electrodes are in selective electrical communication with one of the first electrode and the second electrode with a switching layer.

14. An electro-optic device comprising:
a first substrate;
a second substrate;
a first electrode coupled to the first substrate and a plurality of intermediate electrodes coupled to the second substrate;
an electro-optic medium disposed between the first electrode and the plurality of intermediate electrodes and configured to be electro-activated between states; and
a plurality of transistor arrays in electrical communication with the electro-optic medium through the plurality of intermediate electrodes to switch localized regions of the electro-optic medium between states.

15. The electro-optic device of claim 14, further including a second electrode disposed between the second substrate and the plurality of intermediate electrodes.

16. The electro-optic device of claim 15, wherein each of the intermediate electrodes defines a hexagonal shape with six sides.

17. The electro-optic device of claim 16, wherein each of the intermediate electrodes are disposed in rows and columns and one of the rows and columns are staggered.

18. The electro-optic device of claim 14, wherein the plurality of transistor arrays each include a central transistor connected centrally to different ones of the intermediate electrodes.

19. An electro-optic device comprising:
a first substrate;
a second substrate;
an electro-optic medium disposed between the first substrate and the second substrate and configured to be electro-activated between states; and
a plurality of transistors in electrical communication with the electro-optic medium to switch localized regions of the electro-optic medium between states, the plurality of transistors disposed in hexagonal lattice.

20. The electro-optic device of claim 19, wherein a plurality of operational traces extend between each of the transistors and a control system for individually providing power to each transistor.
